(19) United States
(12) Patent Application Publication
(10) Pub. No.: US 2026/0350580 A1
(43) Pub. Date: Nov. 5, 2026

(54) System for Federated Digital Identity Verification and Service Provisioning

(71) Applicant: TapText llc, Coral Springs, FL (US)

(72) Inventor: Steve Doumar, Fort Lauderdale, FL (US)

(21) Appl. No.: 19/738,719

(22) Filed: Jul. 13, 2026

Related U.S. Application Data
(63) Continuation-in-part of application No. 19/733,749, filed on Jul. 7, 2026.
Application No. 19/733,749 is a continuation-in-part of application No. 18/655,195, filed on May 3, 2024.
Application No. 18/655,195 is a continuation-in-part of application No. 18/631,042, filed on Apr. 10, 2024, now Pat. No. 12,657,570.
Application No. 18/631,042 is a continuation-in-part of application No. 18/593,911, filed on Mar. 3, 2024, now Pat. No. 12,182,794.
Application No. 18/593,911 is a continuation-in-part of application No. 18/185,993, filed on Mar. 17, 2023, now Pat. No. 11,995,639.
Application No. 18/185,993 is a continuation of application No. 17/409,841, filed on Aug. 24, 2021, now Pat. No. 11,610,193.
Application No. 17/409,841 is a continuation-in-part of application No. 17/360,731, filed on Jun. 28, 2021, now Pat. No. 11,871,308.
Application No. 17/360,731 is a continuation-in-part of application No. 17/229,251, filed on Apr. 13, 2021, now abandoned.
Application No. 17/229,251 is a continuation-in-part of application No. 17/209,474, filed on Mar. 23, 2021, now Pat. No. 11,599,916.
Application No. 17/209,474 is a continuation-in-part of application No. 17/208,059, filed on Mar. 22, 2021, now Pat. No. 11,562,407.
Application No. 17/208,059 is a continuation-in-part of application No. 17/191,977, filed on Mar. 4, 2021, now abandoned.
Application No. 17/191,977 is a continuation-in-part of application No. 17/190,260, filed on Mar. 2, 2021, now Pat. No. 11,532,020.
Application No. 17/190,260 is a continuation-in-part of application No. 17/153,426, filed on Jan. 20, 2021, now abandoned.
Application No. 17/360,731 is a continuation-in-part of application No. 17/085,931, filed on Oct. 30, 2020, now Pat. No. 11,055,736.
(60) Provisional application No. 63/154,357, filed on Feb. 26, 2021.
(60) Provisional application No. 63/166,391, filed on Mar. 26, 2021.
(60) Provisional application No. 63/211,496, filed on Jun. 16, 2021.
(60) Provisional application No. 63/519,562, filed on Aug. 14, 2023.
(60) Provisional application No. 63/519,559, filed on Aug. 14, 2023.

(51) Int. Cl. G06Q 20/32; G06Q 20/40; H04W 4/80

(52) U.S. Cl. CPC G06Q 20/3276; G06Q 20/4014; H04W 4/80

(57) ABSTRACT

A system for intelligent interaction control with bounded artificial intelligence decision components. The system comprises an interaction control server, messaging gateway, and bounded AI decision layer that generates structured policy objects, interaction memory objects, and protocol recommendations. AI components function as advisory layers generating structured outputs evaluated by deterministic enforcement components against opt-in state and channel eligibility constraints. Identity-anchored memory objects enable cross-campaign continuity, suppressing redundant engagement. The architectural separation between AI inference and deterministic execution enables adaptive behavior while maintaining regulatory compliance.

### CROSS-REFERENCE TO RELATED APPLICATIONS

Priority is claimed in the application data sheet to the following patents or patent applications, each of which is expressly incorporated herein by reference in its entirety:
Ser. No. 19/733,749
Ser. No. 18/655,195
Ser. No. 18/631,042
Ser. No. 18/593,911
63/519,562
Ser. No. 18/185,993
Ser. No. 17/409,841
Ser. No. 17/360,731
Ser. No. 17/229,251
63/166,391
Ser. No. 17/209,474
Ser. No. 17/208,059
Ser. No. 17/191,977
Ser. No. 17/190,260
Ser. No. 17/153,426
63/154,357
Ser. No. 17/085,931
63/211,496
63/519,559

### BACKGROUND OF THE INVENTION

### Field of the Art

The disclosure relates to the field of computer-based communication systems, and more particularly to the field of ecommerce and artificially intelligent agents.

### Discussion of the State of the Art

Modern engagement platforms increasingly rely on messaging-based interactions to connect users with automated systems, human agents, or downstream service endpoints. Such systems commonly support multiple communication protocols, including SMS, MMS, email, web-based messaging, and rich communication services (RCS). To manage these interactions, existing platforms typically employ static rules, manually configured workflows, or rigid decision trees that determine how and when messages are sent, which protocol is used, and when interactions are escalated or terminated. These conventional approaches suffer from several limitations.

First, personalization logic is commonly implemented using fixed heuristics or campaign-specific rules that do not adapt effectively over time or across campaigns. As a result, users are frequently subjected to repetitive outreach, redundant qualification questions, or poorly timed engagement attempts that increase friction and reduce responsiveness. Conventional systems treat each campaign as an isolated interaction context, forcing users to repeatedly provide the same information across different marketing initiatives or service interactions.

Second, protocol selection logic is often simplistic and channel-centric. Enhanced messaging protocols such as RCS are typically treated as monolithic channels that are either fully enabled or entirely bypassed, without nuanced reasoning about which interaction elements actually require enhanced capabilities or whether partial use of such capabilities would be more appropriate. Existing systems fail to evaluate protocol affordances at a granular level based on interaction requirements, device capabilities, and user responsiveness patterns.

Third, existing systems rarely maintain interaction memory at the routing or protocol layer. While customer relationship management systems may store historical records, such data is not generally used in real time to suppress redundant engagement, guide protocol usage, or inform interaction sequencing decisions at the moment of user contact. The absence of identity-anchored, cross-campaign memory creates inefficiencies and poor user experiences.

Fourth, recent attempts to introduce artificial intelligence into engagement platforms have largely focused on unconstrained conversational agents or message-generation systems. These approaches often blur the boundary between system control logic and conversational output, leading to unpredictable behavior, compliance risks, and difficulty in integrating AI-driven decisions with opt-in requirements, protocol eligibility constraints, and regulatory obligations.

What is needed is an engagement system that can reason intelligently about user interactions without relinquishing deterministic control over messaging execution, protocol compliance, and consent enforcement, that adapts engagement behavior over time based on accumulated interaction context, that maintains and reuses compact representations of prior interactions across campaigns, and that leverages artificial intelligence in a bounded, auditable manner producing structured system decisions rather than unrestricted conversational output.

### SUMMARY OF THE INVENTION

Accordingly, the inventor has conceived and reduced to practice, a system for intelligent interaction control with bounded artificial intelligence decision components, comprising: an interaction control server configured to receive user interactions, manage session state, and coordinate engagement behavior; a messaging gateway configured to transmit and receive messages over multiple communication protocols; an identity management service configured to maintain persistent user identity profiles anchored to communication identifiers; an opt-in state manager configured to capture and enforce user consent states governing permissible messaging behavior; a bounded AI decision layer, comprising: a policy generation service configured to generate structured policy objects from identity profiles, wherein policy objects encode permitted message types, suppressed content categories, and timing constraints; a memory processor configured to generate interaction memory objects from interaction history, wherein memory objects are identity-anchored and reusable across multiple campaigns; and a protocol reasoning service configured to generate protocol recommendations based on interaction intent and device capabilities; wherein the interaction control server evaluates AI-generated outputs against opt-in state prior to executing messaging actions; and wherein the system enables cross-campaign continuity through identity-anchored memory objects that suppress redundant engagement.

Further, according to an embodiment of the invention, the system wherein the bounded AI decision layer further comprises a next-best-action component configured to select engagement actions from a predefined action space.

Further, according to an embodiment of the invention, the system wherein the memory processor generates memory objects comprising indications of questions already answered by users and content previously declined by users.

Further, according to an embodiment of the invention, the system wherein the protocol reasoning service evaluates whether interactive buttons or rich media presentation are required for interaction intent.

Further, according to an embodiment of the invention, the system wherein the messaging gateway comprises a protocol enforcement layer configured to override protocol recommendations when channel eligibility constraints are not satisfied.

Further, according to an embodiment of the invention, the system wherein policy objects are revised based on subsequent user behavior contradicting prior policy assumptions.

Further, according to an embodiment of the invention, the system wherein the bounded AI decision layer further comprises a trust estimator configured to generate readiness indicators representing inferred user engagement disposition.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary and are not to be considered as limiting of the scope of the invention or the claims herein in any way.

FIG. 1 is a block diagram illustrating an exemplary system architecture for a dynamic-link communication platform.

FIG. 2 is a block diagram illustrating an exemplary architecture for message gateway.

FIG. 3 is a block diagram illustrating an exemplary use of a message gateway.

FIG. 4 is a block diagram illustrating an exemplary architecture for a management service.

FIG. 5 is a block diagram illustrating exemplary data within one or more data stores.

FIG. 6 is a block diagram illustrating exemplary content that may be served by a dynamic-link communication platform.

FIG. 7 is a block diagram illustrating exemplary rules that may be used by a dynamic-link communication platform.

FIG. 8 is a block diagram illustrating exemplary initiators used to facilitate dynamic-link communications.

FIG. 9 is a flow diagram illustrating an exemplary method for initializing a dynamic-link communication platform.

FIG. 10 is a flow diagram illustrating an exemplary method for implementing a dynamic-link communication platform.

FIG. 11 is a flow diagram illustrating an exemplary method for facilitating multimodal communications.

FIG. 12 is a block diagram illustrating an exemplary hardware architecture of a computing device.

FIG. 13 is a block diagram illustrating an exemplary logical architecture for a client device.

FIG. 14 is a block diagram showing an exemplary architectural arrangement of clients, servers, and external services.

FIG. 15 is another block diagram illustrating an exemplary hardware architecture of a computing device.

FIG. 16 is a block diagram illustrating an exemplary system architecture for a dynamic-link verification platform.

FIG. 17 is a flow diagram illustrating a method for verifying a user via a mobile device and reverse lookup.

FIG. 18 is a block diagram illustrating an exemplary federated network architecture for dynamic-link verification with enterprise nodes and distributed ledger.

FIG. 19 is a block diagram illustrating an exemplary system architecture for a dynamic-link verification platform with AI-enhanced digital identity wallet integration.

FIG. 20 is a block diagram illustrating an exemplary system architecture with intelligent user experience layer incorporating generative AI and service orchestration capabilities.

FIG. 21 is a block diagram illustrating an exemplary detailed architecture of a federation controller with enterprise management functions for coordinating verification services across federated enterprises.

FIG. 22 is a block diagram illustrating an exemplary system architecture for intelligent interaction control incorporating bounded artificial intelligence decision components.

FIG. 23 is a block diagram illustrating an exemplary interaction memory processing flow and cross-campaign continuity mechanism enabled by identity-anchored memory objects.

FIG. 24 is a block diagram illustrating an exemplary AI-assisted protocol capability reasoning process that enables granular, context-aware selection of communication protocols and messaging affordances.

FIG. 25 is a flow diagram illustrating an exemplary method for policy-governed interaction control using artificial intelligence components, evaluates proposed actions against those policies, and enforces compliance through deterministic decision logic.

### DETAILED DESCRIPTION OF THE INVENTION

The inventor has conceived, and reduced to practice, a system and method for a dynamic-link verification process between an electronic device and a transaction or event. The first step is engagement by a mobile electronic device with an initiator that is linked with a specific verification event that triggers a text message to auto-populate on a mobile electronic device. The message comprising metadata about the user and the event or transaction. The second step is for the electronic device to send the auto-populated message to a message gateway thus initiating the verification of the user. The message gateway works with a management service and one or more databases to verify the identify and other aspects of the user based on instructions provided by the event host. Approval or denial of the transaction or request to gain entry is sent to the mobile device and the event host. The event host may be an electronic device that when it receives an approval performs some action relating to the event or transaction.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

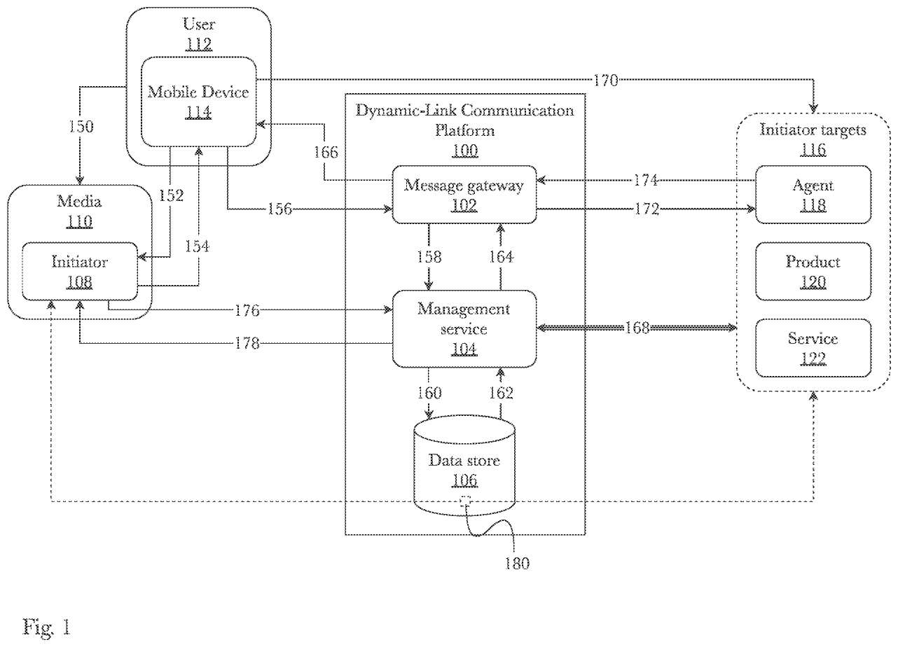

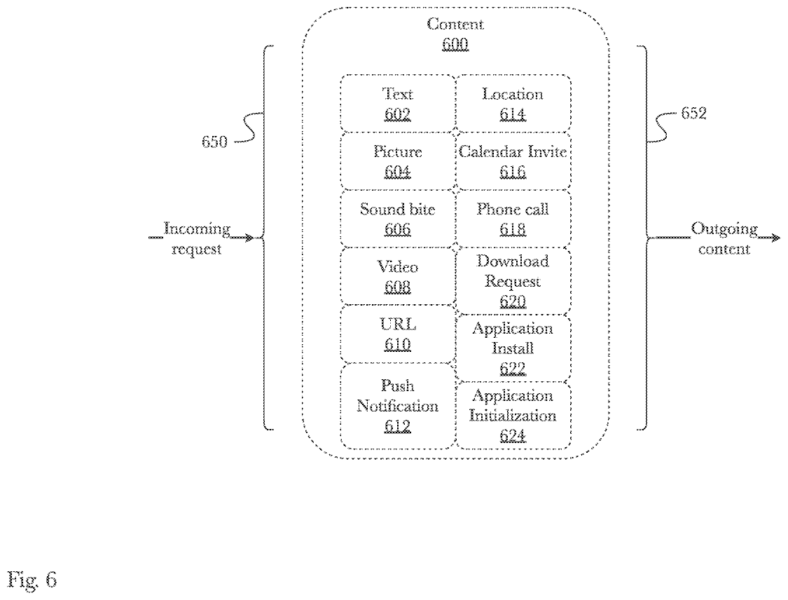

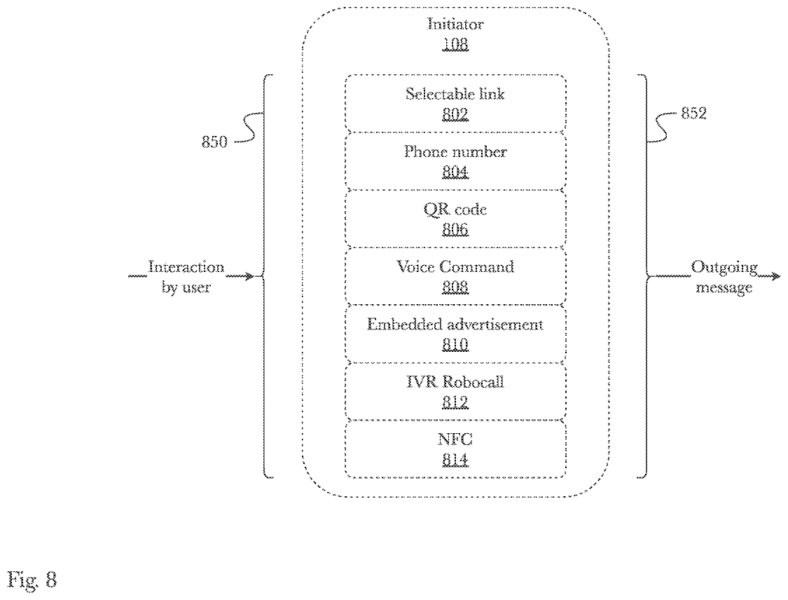

FIG. 1 is a block diagram illustrating an exemplary system architecture for a dynamic-link communication platform 100. Dynamic-link communication platform 100 links an initiator 108 with some type of content or call-to-action associated with a target product or service 116. An initiator 108 may take on many forms, a preferred form being a QR code, however other forms are anticipated in a non-exhaustive list in FIG. 8. The content served may also take many forms, a preferred form being a text or URL associated with a product 120 or service 122, however other forms are anticipated in a non-exhaustive list in FIG. 6. Actions are typically, but not limited to, communicating with some type of agent 118, be it a sales agent, technical support agent, or other types of representatives.

Initialization of dynamic-link communication platform 100 comprises storing content and rules associated with a product 120 or service 122 in some form of computer memory 106, i.e., in a database, federated data store, or distributed ledger, etc. The content and rules are assigned an initiator ID that is unique to that product 120 or service 122 and everything related to that product 120 or service 122 (e.g., content, rules, initiator ID, etc.) is called a campaign 180. The initiator ID may be autogenerated by an algorithm, or taken sequentially from a list, or other methods known to those in the art. Additionally, neither the content nor the rules together are a requirement, but each campaign must have at least one or the other or both. For example, a campaign for a product sold online may have no rules and the only content is a URL to the product page for that product. Or in another example, a marketing campaign attempting to get users 112 to speak to a sales representative may have only a set of rules that forward the user's 112 phone number to a phone number of the business. However, in some situations, there may be content and rules, whereby it may be possible to only forward the content based on some part of the user's 112 metadata embedded in the auto-populated message.

Other rules may comprise routing instructions or routing logic and may further use Artificial Intelligence (“AI”) techniques known to those skilled in the art including deep learning algorithms and incorporate data resources as listed in previous paragraph along with an array of other factors including but not limited to time-of-day, day-of-week, store hours, resource availability, service level requirements, previous customer interaction and transactions, customer tiering structure, data from 3^{rd} party systems including but not limited to CRM systems, location-based services, weather-services and so forth.

With a unique initiator ID for a product 120 or service 122 in place, an initiator 108, such as a QR code, may be generated. It is not necessary to always generate the initiator 108 with a dynamic-link communication platform 100. According to one embodiment, initiators 108 may also be received alongside the content and rules. Generated initiators 108 may be sent, forwarded, printed, mailed, or hosted on some form of media 110. Media 110 in this sense is referring to the many forms that an initiator may be placed. A non-exhaustive list includes printed materials such as billboards, posters, and flyers; and electronic means such as online advertisements, embedded advertisements, URLs, push notifications, streaming media, etc.

With the dynamic-link communication platform 100 initialized, a user 112 will observe 150 media 110 with an initiator 108, use his or her device—such as a mobile device 114—to engage 152 with an initiator 108, for example scanning a QR code, which will trigger the device 114 to auto-populate a text message 154. The user 112 will simply press the send key/button to send the message 156. In the case the initiator 108 is a QR code, then the destination of the message and other data may be embedded in the QR code such that the embedded data is then transferred along with the message to the dynamic-link communication platform 100 so that the dynamic-link communication platform 100 knows the context in which the message was sent. In almost every case there may be a way two derive context from a message. Take for example, three billboards all directed to the same product 120/campaign but each containing a different phone number, where the phone number is the initiator 108 and shares the same initiator ID. In this case a user will dial the phone number and be returned the content (e.g., a text message with the product information) and the number that was dialed gives context as to the location of the billboard and the user 112. In a case where the media 110 does not allow for context, but the initiator 108 has Internet access, the initiator 108 may communicate 176/178 with the management service component 104 of a dynamic-link communication platform 100 in order to provide context as well as deliver and confirm compliance with rules if applicable.

The message sent 156 from the device 114 is received by a message gateway 102 and forwarded 158 onto a management service 104. The message gateway 102 receives and sends messages from various modes of communication, e.g., text, email, voice, and other protocols. The initiator ID contained in the message is used to query 160 a data store 106 which will return 162 any content and rules associated with that initiator ID. Upon compliance with any rules, and if there is content to be delivered back to the device 114, then the content is sent 164 to the message gateway 102 for sending 166 back to the device 114. If the message was a request to communicate with an agent 118, then upon compliance with any rules, the message or content will be sent to the message gateway 102 for delivery 172 to the agent 118. The agent 118 if applicable, will send a return message 174, and that return message will again go to the management service 104 for rule compliance before being delivered to the device 114. Some content to be delivered to the device will contain external links 170 to the products 120 and services 122. Content, rules, and provided initiators 108 may be dynamically updated via communication lines 168 with the initiator targets 116. For example, if the URL to a product changes, the product owner may push updated content to replace the old content in the data store 106.

Customers/users and their devices 114, agents 118, 177 and their business user mobile device(s), other business user device(s), and TCPA compliant mobile device(s) used by agents 118, may connect to a dynamic-link communication platform 100, typically via a cellular phone network, although connections may be made through other means, as well, such as through the Internet via a Wi-Fi router for example. Similarly, devices may connect to over a Local Area Network (“LAN”) or Wide Area Network (“WAN”), the Internet, a direct physical connection to another device, or some other network connection. Dynamic-link communication platform system 100 may connect to 3^{rd} party or external systems or components, such as Customer Relationship Management (“CRM”) systems, Private Branch Exchange (“PBX”), traditional telephony call center agents, voicemail systems, and so forth, through 3rd party data gateway.

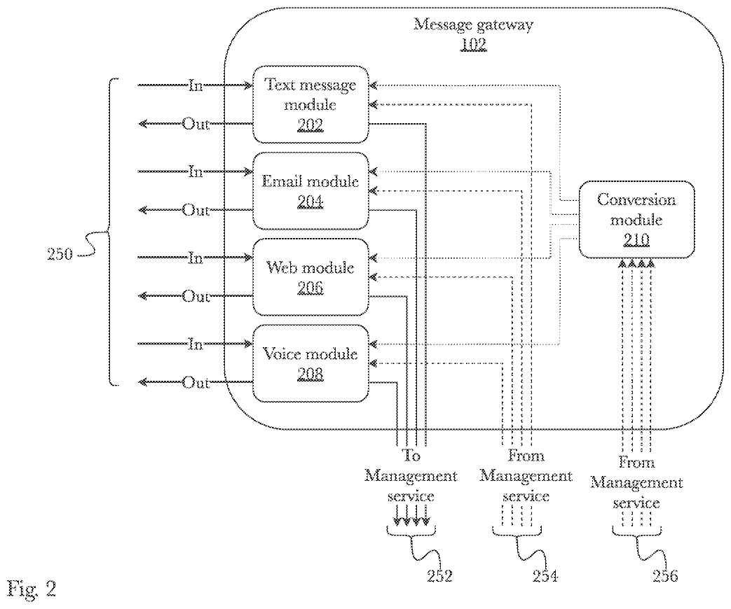

FIG. 2 is a block diagram illustrating an exemplary architecture for message gateway. The message gateway 102 may comprise various modules 202-208 which send and receive 250 different modes of communication. A conversion module 210 may be implemented which is dedicated to converting between different modes of communication. However, the arrangement of these modules and their inherent functions need not be arranged in the manner illustrated in FIG. 2. Another anticipated embodiment employs third-party gateway services where and if possible, such as an SMS-to-email gateway, however it may be more efficient to centrally perform the conversions, especially with regard to privacy.

Messages received 250 by the modules are sent to management service 252. The returned content or response messages from the management service may already be formatted in the proper format for the respective module 254. Returned content or response messages not properly formatted 256 may get formatted by the conversion module before going out to the proper module 202-208.

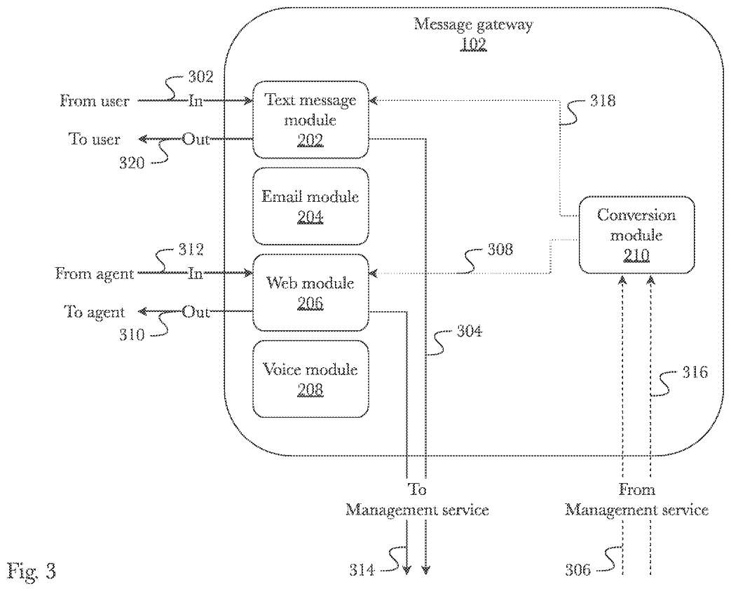

FIG. 3 is an example of a user engaging with an initiator that is intended to connect the user with a sales agent using a web-enabled chat interface. A user will interact with an initiator and then send the generated message which will be received 302 by a text message module 202. The text message module 202 may contain instructions to send and receive wireless protocols typically used for mobile devices such as SMS, MMS, iMessage, RCS, etc. The message is sent to the management service 304 where the initiator ID from the message will identify the campaign and subsequently at least one or more agents to query if they may respond to the request. The rules of the campaign may set forth what content the message to the agent contains. For example, the first message may just contain a query to approve or deny the request. According to another embodiment, the original message plus any metadata about the user or request may be slotted into an agent's queue. Many possibilities exist as to what the messages may contain and are not limited to the examples set forth herein. Irrespective of what the messages may contain, a message is sent to an agent 308/310 via the web module 206, however not before the text message is converted into the appropriate format 306 for the web module 206. The response from the agent 312 is sent to the management service for rule compliance 314 and then back 316 to the message gateway 102 conversion module 210 so that it may be converted into a text format to be set to the user 318/320.

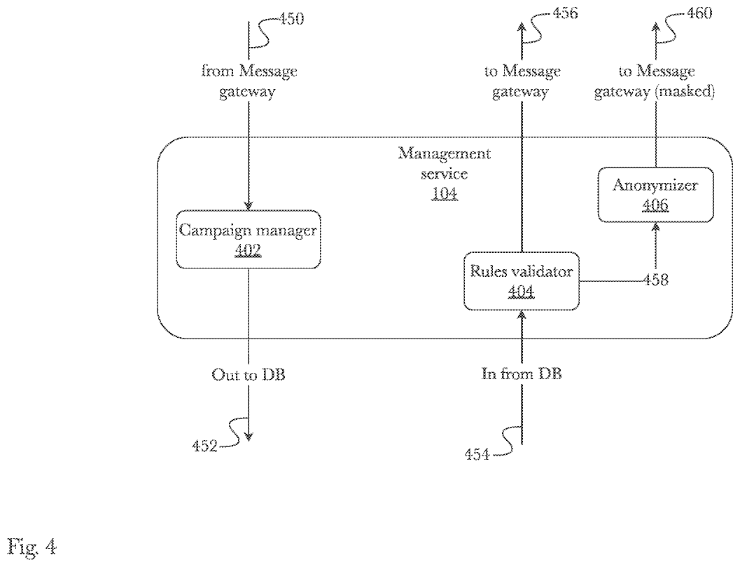

FIG. 4 is a block diagram illustrating an exemplary architecture for a management service 104. Messages from the message gateway are received 450 by the management service 104 and a campaign manager 402 uses the message initiator ID to retrieve the associated content and rules from one or more databases 452/454 and sends the rules to a rules validator 404. If there are no rules and only content to be served, then the content will simply be sent out to the message gateway 456. If a campaign from the one or more databases does contain one or more rules however, the rules validator 404 ensures that all the requirements of the campaign are met before sending the content or executing a specific action is performed. One example is that a rule may dictate that the message be stripped of private information before it is forwarded or used, and in such a case, the message will be sent to an anonymizer 406 before the message is sent 458 to the message gateway 460. The anonymizer 406 removes personally identifiable information (PII) from messages using machine learning algorithms such as natural language processing or natural language reasoning. Rules may go as far as being employed to prescreen the source of the message using the metadata embedded into the message as a way to discriminate whether or not the contents of the campaign may be allowed to be sent to the message sender.

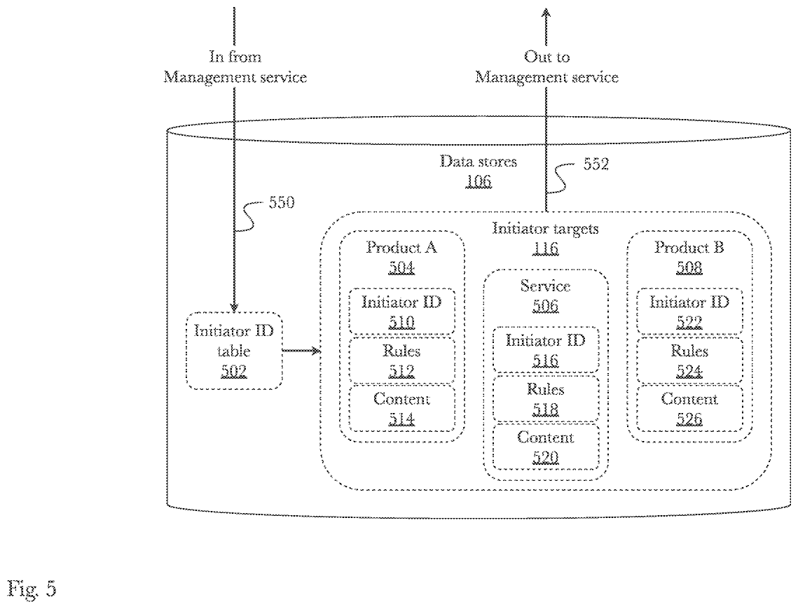

FIG. 5 is a block diagram illustrating exemplary data within one or more data stores 106. This diagram illustrates an exemplary logical representation of one way to organize and store data associated with an initiator in one or more data bases. In this arrangement an initiator ID table 502 stores a list of initiator IDs, each of which are linked with a memory address associated with each initiator target 116, i.e., campaign 504-508, in the data store. In this way, content and rules may be efficiently retrieved from the management service 550/552. According to this embodiment, each campaign 504-508 has at least their own set of rules 512/518/524, content 514/520/526, and an initiator ID 510/516/522.

Database(s) 106 may take the form of a managed or unmanaged database, document-oriented database system, or a Structured Query Language (“SQL”) database. Examples of types of database software that may operate include MYSQL™, ORACLE DATABASE™, MONGODB™, and others. It may exist as a distinct physical device or be operating on another computing device that may perform other functions aside from operating, hosting and serving the database 106. If it is a distinct physical device, the database may be connected over a LAN or WAN, the Internet, a direct physical connection to another device, or some other network connection.

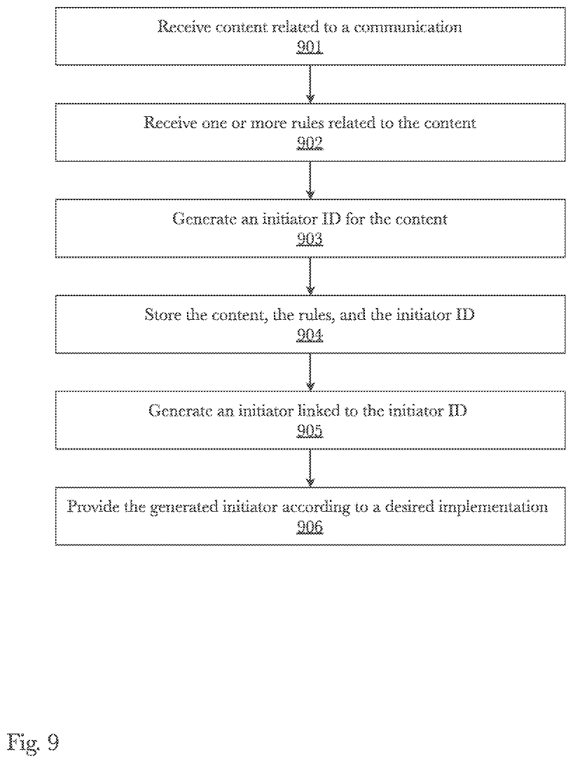

FIG. 9 is a flow diagram illustrating an exemplary method for initializing a dynamic-link communication platform. Regarding the steps in this diagram, there is no strict requirement for the steps to be in this particular order. For example, content and rules may be received at the same time and stored before the initiator ID is generated. It will be appreciated by those skilled in the art that the general process is to populate a database with the content to be served, the rules related to how that content is served and to whom, and then to generate and link an initiator and initiator ID such that it may actually be served.

In a first and second step 901/902 content and one or more rules related to the content are received. In a third step 903, an initiator ID is generated or retrieved for the campaign, where the campaign is all of the data associated with that particular product or service. Initiator IDs may be issued sequentially or according to an algorithm, and the initiator ID's may also be used to identify campaigns, if so desired. In a fourth step 904, the content, rules, and initiator ID are stored in a database as a campaign. In a fifth step 905, an initiator is generated according to the provisions of the campaign. It is also anticipated that an initiator does not necessarily have to be generated, but may also be received along with the content and rules. It should be understood that whether an initiator is generated or received, it is inherently linked with the initiator ID of the associated campaign. In a six step 906, the initiator is deployed according to the stipulations of the campaign. It is anticipated that there may be many initiators taking various forms of which all link to one initiator ID.

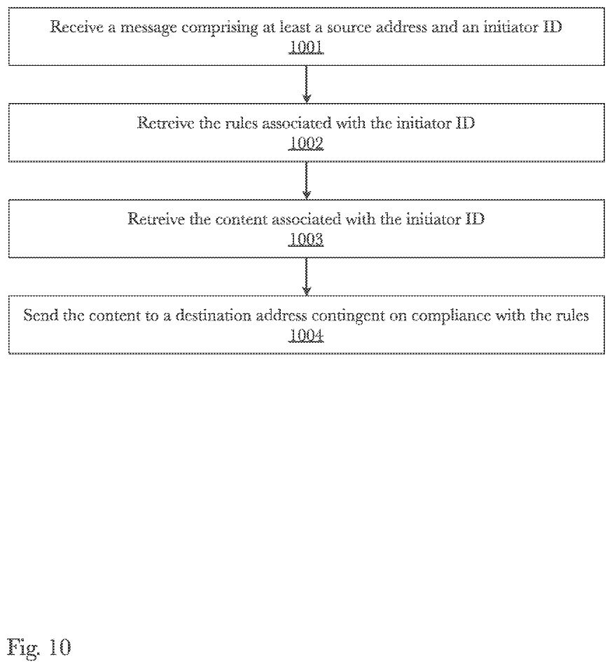

FIG. 10 is a flow diagram illustrating an exemplary method for implementing a dynamic-link communication platform. In a first step 1001, a message is received comprising at least the originating source address and an initiator ID. In a second step 1002, rules associated with the initial ID are retrieved. In a third step 1003, content associated with the initiator ID is retrieved. In a fourth step 1004, the content is sent, or the action triggered by the rules is executed, only upon compliance with the rules associated with that campaign.

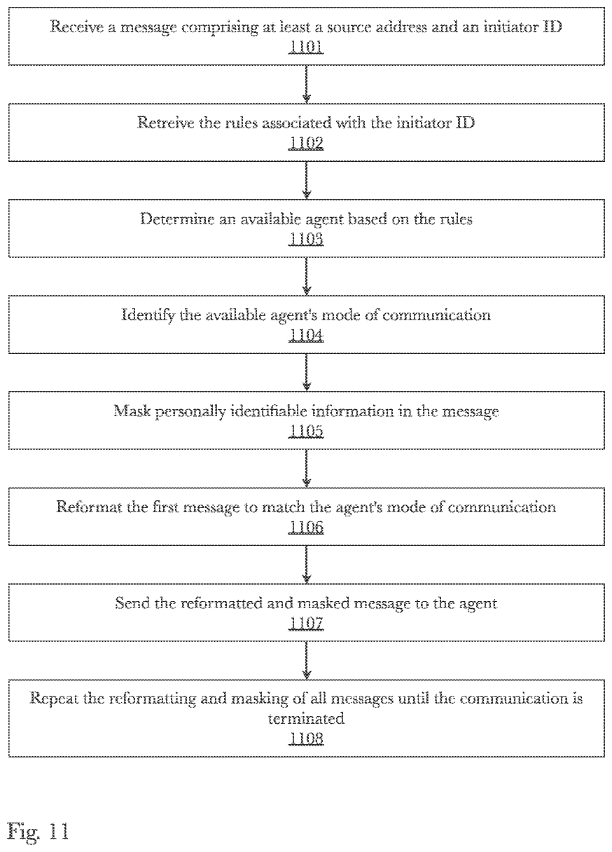

FIG. 11 is a flow diagram illustrating an exemplary method for facilitating multimodal communications. In a first step 1101, a message comprising at least an originating source address and an initiator ID is received. In this case, the campaign—via the initiator—generating the message is intended to initiate a communication between the user and an agent. More particularly, initiate and facilitate a privacy-compliant communication between a user's device and an agent's device. In a second step 1102, the initiator ID is used to retrieve the rules for the campaign. In a third step 1103, the rules are used to determine which agent contact and when. In a fourth step 1104, the selected agents mode of communication is identified. Additionally, in this scenario, the motive communication of the user and the motive communication of the agent or not the same. In a fifth step 1105, personally identifiable information is masked or removed in the message received in step 1101. In a sixth step 1106, the message received in step one 1101 is reformatted to match the agent's mode of communication. In a seventh step 1107, the masked and reformatted message is sent to the agent. In an eighth step 1108, all subsequent messages of the communication between the user's device and the agent's device are formatted and masked appropriately until the communication is terminated.

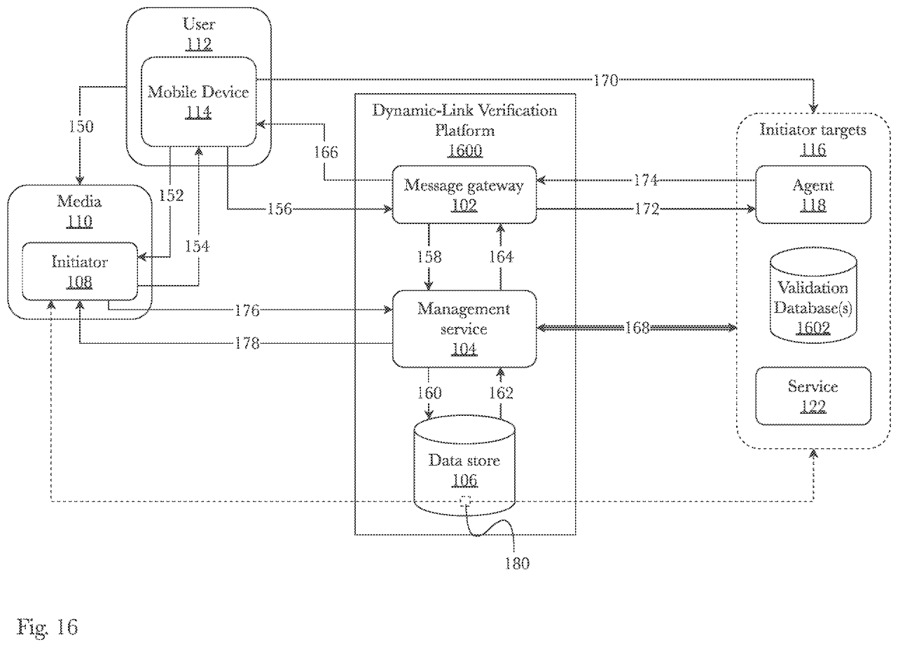

FIG. 16 is a block diagram illustrating an exemplary system architecture for a dynamic-link verification platform 1600. A dynamic-link verification platform 1600 functions in much the way of a dynamic-link communication platform 100 in FIG. 1. However, one or more validation databases 1602 have taken the place of a product for use in authorizing individuals at business establishments, public parks and venues, and other places where authorization/validation may be utilized. In general, a user 112 attempts to conduct an ecommerce transaction or attempts to enter a controlled space. In both scenarios, an initiator 108 may be presented to the user 112 so that the mobile device 114 may interact with the initiator 108 whereby the initiator 108 triggers the mobile device 114 to auto-populate a text message relating to the ecommerce transaction or the request to gain entry into the controlled space. It is possible that more than one initiator 108 is present such as the case if there are multiple events at one venue, and other like-situations. The mobile device 114 sends the auto-populated text message and it is received by the message gateway 102. The text messages forwarded on to the management service 104 where the initiator ID is used to retrieve a rule relating to the e-commerce transaction or request for entry, or as defined hereafter a verification event. The rule contains instructions for the management service 104 to perform in order to verify the owner of the mobile device 114. Rules may comprise various instructions, some of which are disclosed in the following examples.

A first example may be used at a concert and requiring users to have full vaccination status against a coronavirus in order to gain entry. The instructions contained in the rule in this scenario may be to use the phone number of the mobile device 114 against the billing information associated with the mobile device's 114 carrier to determine the name of the user 112. Subsequently, use the name on the billing information against the CDC's vaccination whitelist. Then, contingent on the successful verification of the first two steps, compare the name of the vaccinated user against the guest list provided by the verification event host. Lastly, send an approval notification to the event host. It should be noted that the event host is not a person, but may be another electronic device which may unlock a gate, send a message, activate the printer, complete a transaction, etc.

A second example may be an ecommerce transaction where in the consumer is attempting to purchase alcohol that is restricted to anyone under the age of 21 years old. The instructions in this scenario may require the user to provide biometrics on the mobile device 114 and use the biometrics to compare against a government database.

According to one use case, a consumer may go to an ecommerce website to purchase a product or service that requires his or her identity to be verified. On the product page 110 for that ecommerce item, there may be a selectable item—i.e., an initiator 108—such as a link or a button that may say something to the effect of “verify” or something of the like. When the consumer 112 interacts with this initiator 108, a message will be auto-generated on their mobile device 114. The message destination will go to a dynamic link verification platform 1600 so that the management service 104 can first check any local data stores 106 to see if the validation may be confirmed, and if not reach out to one or more validation databases 1602 over a network. Validation of the user 112 of the mobile device 114 may happen in the following non-exhaustive list of examples: a third-party reverse lookup service matching the phone number to the consumer's name; matching some or all of the billing information of the mobile device to the consumer's name; using API's of other third-party verification databases, or using verification methods present on the mobile device—e.g., biometrics, security applications, and partner applications. According to one embodiment the data store 106 may be used to store the user's 114 validation status. In this way, a data store 106 may build up a list of users who are pre-verified and to what extent they are pre-verified. According to one aspect, a distributed ledger may provide a private and secure means to store such a pre-verified list of users. Upon verification of a user's identity, the dynamic-link verification platform 1600 may send an approval to the ecommerce provider so that the transaction may be completed.

An additional use case may be using a validation platform 1600 to control entry into a public place, event, or venue based upon the condition that the individual has the appropriate vaccines. The management service 104 may reach out to a federated database comprising databases such as the CDC, hospital chains, etc. It may use the same local data store 106 and distributed ledger as mentioned previously. There may be multiple levels of validation depending on the context of the situation. For example, it is possible that a user has all of his or her vaccines and it is recorded as much in a database and upon a validation request, the user is verified as green, signifying that the user may attend the current and all future events contingent on the fact that the rules don't change regarding what vaccinations are required period. However, consider a second person who is also fully vaccinated but their vaccination information has yet to be uploaded to any database. This person may be manually verified by a person working the gate at a public event, such that after manual verification, the user's status may be stored in the local database 106 as yellow, signifying that they are only validated this one time and they must be validated again the next time they visit any establishment. It may be also that a user is not able to be manually or automatically verified according to their vaccination status, therefore a user 112 requesting to get in using their mobile device 114 and engaging with an initiator 108 would be denied entry and would be flagged as red signifying that they are not allowed entry into the event. The different verification levels—green, yellow, and red—may be used to print out wristbands of different colors, or provide different information in the form of a text message to the mobile device. The different statuses may be used to control what areas of the venue the person is allowed to be at. For example, at a restaurant, a user with a green status may be able to dine indoors while users with only a yellow status may only dine outdoors. With regards to providing different information in the form of a text message, keep in mind that the dynamic link verification platform 1600 has the capabilities to store that information and provide it upon receiving the auto-populated text message from the mobile device 114, as disclosed in at least FIG. 1.

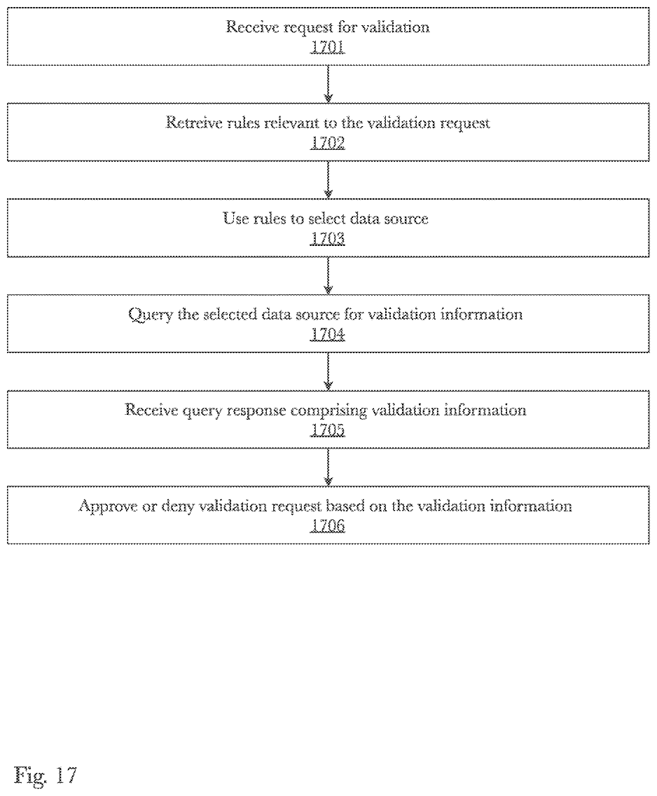

FIG. 17 is a flow diagram illustrating a method for verifying a user via a mobile device and reverse lookup. As described in various previous figures, the general invention is a system and method for initiating some form of communication between at least two entities. This communication is initialized by providing a user with a mobile device some means by which they may initiate a communication related to some product or service the person is interested in. Such means may comprise a billboard with a phone number or a URL, or an advertisement on a bus stop with a QR code, or may comprise an online advertisement that is selected or clicked by the user, among many other options and combinations. When the user interacts with the advertisement (e.g., goes to the URL, clicks on the advertisement, scans a QR code, etc.) a text message is auto populated on the user's device. As fully described in the previous figures, but generally re-described here, is that the means to produce both the content of the text message and the text message itself may happen in various ways. The content of the text message may be retrieved from the URL, or may be embedded within the QR code, or originate from the advertisement that was selected. As with the exemplary means in the previous statement, each means may also have a way to embed other contextual information for the purposes of communication satisfaction. This “other context” may include the time the interaction was initiated, locality data, identifying information from the mobile device or user, campaign matching information, and other data and metadata useful for such interactions. Once the text message and all of its content is populated on the users device the user may just simply hit the send button. That text message is now received by a service that facilitates a privacy compliant communication relevant to the advertisement/product/service. One example is when a user selects an online advertisement, say to buy specific car, information from the user's device and information contained by or retrieved by the advertisement campaign is used to auto populate a message which is then sent by the user. That text message and the relevant information is used by service to find and connect the user with an agent at the dealership and even further mask any private information on both ends of the communication, i.e., remove all personally identifiable information such as phone numbers and names.

FIG. 17 comprises a method of adding a validation service to the system and method described above. Where a user will still interact with some form of media, advertisement, or content, but where the interaction further requires that the user be validated. Many levels of verification are anticipated. One verification method comprises using the phone number of the mobile device which initiated the communication to perform a reverse lookup and compare the person associated with the phone number (or billing information) with the person attempting to initiate the interaction. This verification method can be supplemented with any level of authentication so desired. This may mean a username and password, biometrics, some third party authentication service, and other types of authentication services in use. If the user has been successfully verified, then an approval to complete the transaction, allow entry, or some other action may occur. Using the example of the car advertisement, a user may be pre-verified or preauthorized for the vehicle purchase just by authenticating themselves when they click on the advertisement. This can apply generally to any ecommerce platform. Furthermore, the validation service may comprise a federated data store or a distributed ledger, private or public, or other forms of robust data services needed to facilitate authentication transactions. Databases and data store services may be local or distributed or some combination thereof. For example, a local database may be populated from a federated data store as users are validated, removing the need to query the federated data store if a user already exists as validated in the local database. The validation service may also comprise a set of rules, also the rules may be local or retrieved from some rules database, and the rules tell the service how to validate, at what level to validate, and at what level each person is validated—if there is more than one level of validation. One example of this, is where a person requesting access into a public venue is provided access to certain areas only if they have received one or more vaccines. In such a case it may be that the person is not verified of receiving the vaccine if any of the databases within the federated data store reflect as much, but the person has received a valid vaccination card that can be verified manually by someone at the gate/entry. Such a case may happen if the person has just received a vaccine and that information has not been entered into any of the databases. And if that is the case, then it is possible to flag the user as validated and allow them access to the venue but perhaps not into specific areas or that the person is only allowed access for a specific period of time and must always be reverified until the federated or local data store reflects the manual verification of the vaccine card. The local database may use many types of technologies, one anticipated method is to use a private blockchain to better protect against privacy and HIPAA violations.

In a first step 1701, a request for validation is received by a validation service. This request may comprise information pertaining to the person or device for which the validation is requested. The request may also comprise information relating to the type of validation or reason for the validation which may be used to determine which rules are relevant to completing the validation request 1702. There may be many rules contained within a rules database or within the validation service. For example, the validation service may be used to perform validations of vaccinations, e-commerce transactions, sales leads, etc. In other words, a request for validating a person or device is received which comprises information which allows the validation service to know how to validate and where to validate from for the request. With the proper rules selected, the validation service now selects the appropriate data sources 1703 from which to query for the purposes of obtaining validation information related to the validation request of the person or device 1704. The rules may tell the validation service where to find the address or location of one or more data sources. The rules may point to a local table, array, or any other type of data storage means by which the logical addresses of data stores may be contained. Once a response to the query containing the appropriate validation information is received 1705, the validation information is compared to the rules which provide a means to know whether the person or device is validated and at what level—should more than one or two levels exist, i.e., the rules confirm approval or denial of the validation request based on the validation information which may then be forwarded onto the requester of the validation 1706.

As previously stated, it is anticipated that a local data store may save the results of these validation requests such that any subsequent validation requests matching the initial request may be first retrieved from the local data store thus increasing the speed and efficacy of the request process rather than querying federated data stores each iteration.

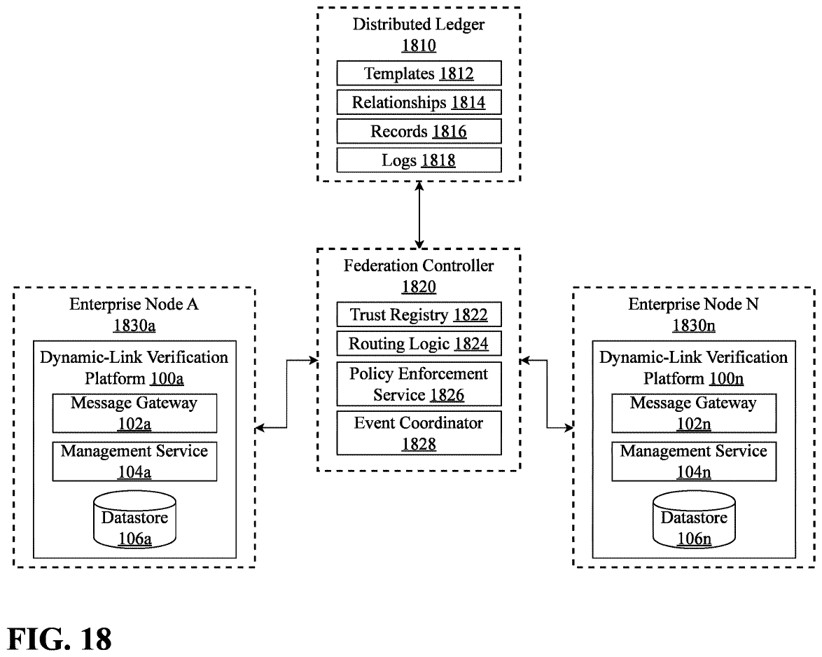

FIG. 18 is a block diagram illustrating an exemplary federated network architecture for dynamic-link verification with enterprise nodes and distributed ledger. The federated verification network comprises a plurality of enterprise nodes, illustrated as Enterprise Node A 1830a and Enterprise Node N 1830n, representing that the network may comprise any number of enterprise participants. Each enterprise node contains a Dynamic-Link Verification Platform 100a, 100n as previously described, comprising a Message Gateway 102a, 102n, a Management Service 104a, 104n, and a Datastore 106a, 106n. The enterprise nodes communicate with a central Federation Controller 1820, which manages the relationships, trust levels, and coordination between all participating enterprises in the federated network.

The federated architecture illustrated in FIG. 18 enables a paradigm shift from isolated, single-enterprise verification systems to a collaborative network where multiple organizations may jointly provide identity verification and service provisioning. In this federated model, a user who has been verified by one enterprise (for example, Enterprise Node A 1830a) may leverage that verification when accessing services at another enterprise (for example, Enterprise Node N 1830n), subject to the trust relationships and policies maintained by the Federation Controller 1820. This eliminates the need for users to undergo redundant verification processes at each enterprise, while still allowing each enterprise to maintain control over their own verification standards and business logic through their individual Dynamic-Link Verification Platforms 100a, 100n. The federation thereby creates a network effect where the value of participation increases as more enterprises join, as users gain access to an expanding ecosystem of services with a single verified identity, while enterprises benefit from shared verification costs and reduced friction in user onboarding.

The Federation Controller 1820 comprises several core functional modules that enable federated operation. A Trust Registry 1822 maintains records of each enterprise's trust level, credentials, and authorization to participate in the federation. Routing Logic 1824 determines how verification requests should be routed between enterprises and which enterprise nodes are best suited to handle particular verification events. A Policy Enforcement Service 1826 ensures that all federated transactions comply with the rules and policies established by the federation and individual enterprises. An Event Coordinator 1828 manages the orchestration of verification events that may span multiple enterprises, ensuring proper sequencing and coordination of multi-party verification workflows.

The federation protocol implemented by the Federation Controller 1820 and Enterprise Nodes 1830a, 1830n operates through a sophisticated multi-layer communication framework that ensures secure, authenticated, and auditable inter-enterprise transactions. At the transport layer, all communications between the Federation Controller 1820 and Enterprise Nodes utilize mutually authenticated Transport Layer Security (TLS) connections, where both parties present X.509 certificates issued by the federation certificate authority. These certificates encode not only identity information but also authorization attributes that specify what types of verification requests an enterprise may issue or fulfill, what credential types they are authorized to work with, and what trust level they currently hold within the federation. The certificate-based mutual authentication ensures that no unauthorized party can inject requests into the federation or impersonate legitimate enterprises.

At the application layer, the federation protocol defines a structured message format for all inter-enterprise communications, typically implemented using JSON Web Tokens (JWT) or similar signed and encrypted message containers. Each federated verification request message comprises several critical components: a unique transaction identifier that enables tracking and correlation across multiple enterprises, the requesting enterprise's identity and authorization credentials, the specific verification requirements including what attributes need to be verified and to what assurance level, user consent tokens proving the user has authorized this specific cross-enterprise verification, routing hints indicating preferred fulfillment enterprises based on user location or service requirements, and cryptographic signatures binding all these elements together. The Federation Controller 1820 validates each incoming request message, checking that the requesting enterprise is authorized to request this type of verification, that the user consent token is valid and covers the requested attributes, that the message signature is authentic, and that the request complies with all applicable policies before routing it to a fulfilling enterprise.

The protocol implements a three-phase commit pattern for verification transactions that span multiple enterprises, ensuring consistency even when network failures or enterprise outages occur during processing. In the preparation phase, the Federation Controller 1820 identifies all enterprises that need to contribute to the verification (for example, Enterprise Node A 1830a might verify identity while Enterprise Node N 1830n verifies payment credentials), sends preparation requests to each, and collects provisional verification results along with cryptographic commitments that these results will remain valid for a specified time window. During the commit phase, the Federation Controller 1820 aggregates the provisional results, evaluates them against the verification requirements and trust policies, and if all requirements are satisfied, instructs each participating enterprise to commit their provisional results to permanent storage and the Distributed Ledger 1810. Finally, in the confirmation phase, the Federation Controller 1820 collects commit acknowledgments from all participants and returns the final verification result to the requesting party. If any enterprise fails to respond during any phase, the protocol includes timeout and rollback mechanisms that ensure partial verifications are not inadvertently accepted and that resources are properly released.

The federation protocol incorporates sophisticated privacy-preserving techniques to minimize information disclosure between enterprises while still enabling verification. When Enterprise Node A 1830a needs to leverage a verification previously performed by Enterprise Node N 1830n, rather than Enterprise Node N revealing the complete verification data to Enterprise Node A, the protocol supports selective disclosure where Enterprise Node N can cryptographically prove specific attributes (such as “user is over 21” or “user has verified government ID”) without revealing the underlying data (the user's actual birthdate or ID number). This is implemented through zero-knowledge proof protocols where Enterprise Node N signs attestations of specific predicates, and Enterprise Node A can verify these signatures against Enterprise Node N's public key recorded in the Trust Registry 1822 without learning any information beyond the truth of the attested predicates. The protocol further supports privacy through the use of pairwise pseudonymous identifiers, where the same user may be known by different identifiers at different enterprises, with the Federation Controller 1820 maintaining the correlation mapping (encrypted and accessible only under specific policy conditions) that enables legitimate cross-enterprise verification while preventing enterprises from correlating user activities across the federation without authorization.

The federated network further comprises a Distributed Ledger 1810 that provides an immutable, shared record of verification events and enterprise relationships across the federation. The use of a distributed ledger architecture provides several critical advantages for federated verification: it eliminates any single point of control or failure, ensures that no individual enterprise can unilaterally alter verification records, provides cryptographic proof of the authenticity and timing of verification events, and enables all federation participants to maintain synchronized views of trust relationships and transaction history without requiring a central database controlled by any one party. The Distributed Ledger 1810 stores several categories of information critical to federated operation. Verifiable Credential Templates 1812 define standardized formats for credentials that may be issued and verified across enterprise boundaries, enabling interoperability between different enterprise verification platforms. These templates specify data schemas conforming to standards such as W3C Verifiable Credentials, cryptographic signature requirements including supported signature algorithms and key strengths, expiration policies defining how long credentials remain valid, revocation mechanisms enabling credentials to be invalidated before expiration when necessary, and binding requirements that specify how credentials must be cryptographically bound to their subjects to prevent credential theft or impersonation. The templates undergo a governance process where proposed templates are reviewed by federation participants and approved through consensus mechanisms before being recorded on the Distributed Ledger 1810, ensuring that all enterprises agree on the semantics and security properties of credential types used within the federation.

Enterprise Trust Relationships 1814 record the trust agreements, authorization levels, and business relationships between enterprises participating in the federation, creating an auditable record of which enterprises may rely on each other's verifications. Each trust relationship entry on the Distributed Ledger 1810 specifies the two enterprises involved, the types of verifications that may be relied upon (for example, Enterprise A might trust Enterprise B's identity verifications but not their credit verifications), the trust level or confidence score assigned to reliance, any specific conditions or limitations on the trust relationship, the effective and expiration dates of the trust agreement, and cryptographic signatures from both enterprises acknowledging the relationship. These trust relationships may form complex graphs rather than simple pairwise connections, where transitive trust may be computed (Enterprise A trusts Enterprise B, and Enterprise B trusts Enterprise C, therefore Enterprise A may conditionally trust Enterprise C with a computed trust level based on the chain). The Trust Registry 1822 in the Federation Controller 1820 maintains a cached and indexed view of these trust relationships for efficient query during request routing, but the authoritative record remains on the Distributed Ledger 1810 where it cannot be tampered with.

User Consent Records 1816 maintain privacy-preserving records of user permissions for cross-enterprise credential sharing and verification, ensuring compliance with privacy regulations such as GDPR, CCPA, and HIPAA. Each consent record cryptographically captures what specific data attributes the user has authorized to be shared, which enterprises are authorized to access this data, for what purposes the data may be used, how long the consent remains valid, and whether the consent may be delegated to other enterprises. The consent records are implemented using privacy-preserving techniques where the actual consent details are encrypted such that only the user (through their Digital Wallet Application) and authorized enterprises can decrypt them, while the Distributed Ledger 1810 maintains cryptographic proofs that valid consents exist without revealing their contents. This enables the Federation Controller 1820 to verify that a cross-enterprise verification request is covered by valid user consent without the Federation Controller itself learning the details of what data is being shared, providing privacy even from the federation infrastructure.

Service Transaction Logs 1818 provide an immutable audit trail of all verification transactions that occur across the federated network, supporting dispute resolution and compliance monitoring. Each transaction log entry records the transaction identifier, the participating enterprises, a cryptographic hash of the verification request and response (without recording the actual personal data, preserving privacy), timestamps for each phase of the transaction protocol, the final outcome, and signatures from all participating parties. These logs enable several critical capabilities: users can audit what verifications have been performed using their credentials and identify any unauthorized access, enterprises can prove they properly fulfilled verification requests in case of disputes, regulators can monitor federation operations for compliance without accessing personal data, and the federation can analyze transaction patterns to detect anomalies that might indicate fraud, system abuse, or compromised enterprises. The immutability of the blockchain ensures these logs cannot be altered after the fact, providing reliable evidence for dispute resolution and forensic investigations.

The Federation Controller 1820 communicates bidirectionally with the Distributed Ledger 1810, both reading trust relationship data and writing transaction records to the ledger. The Federation Controller 1820 operates as a full node in the distributed ledger network, maintaining a complete copy of the ledger and participating in consensus protocols that validate new blocks before they are added to the chain. Similarly, the Federation Controller 1820 maintains bidirectional communication with each Enterprise Node 1830a, 1830n, coordinating verification requests, synchronizing trust data, and orchestrating federated verification workflows. According to one embodiment, Enterprise Nodes may also communicate directly with the Distributed Ledger 1810 to record transactions or query trust relationships, as illustrated by the connection between the enterprise nodes and the ledger. Each Enterprise Node typically operates as a light client of the distributed ledger, maintaining only the portions of the ledger relevant to their operations rather than the complete chain, but with cryptographic proofs that link their partial views to the authoritative full chain maintained by Federation Controllers and other full nodes.

This federated architecture enables multiple independent enterprises to collaborate on user verification while maintaining their own verification platforms and business logic, with the Federation Controller 1820 and Distributed Ledger 1810 providing the coordination and trust infrastructure necessary for secure cross-enterprise operations. The sophisticated federation protocol ensures that cross-enterprise verifications are performed securely with mutual authentication, that user privacy is preserved through selective disclosure and consent management, that transaction consistency is maintained even in the presence of failures through distributed commit protocols, and that all federation operations are auditable through immutable transaction logs. The combination of centralized coordination through the Federation Controller 1820 and decentralized trust through the Distributed Ledger 1810 provides both the operational efficiency needed for real-time verification and the security and accountability required for managing sensitive identity information across organizational boundaries.

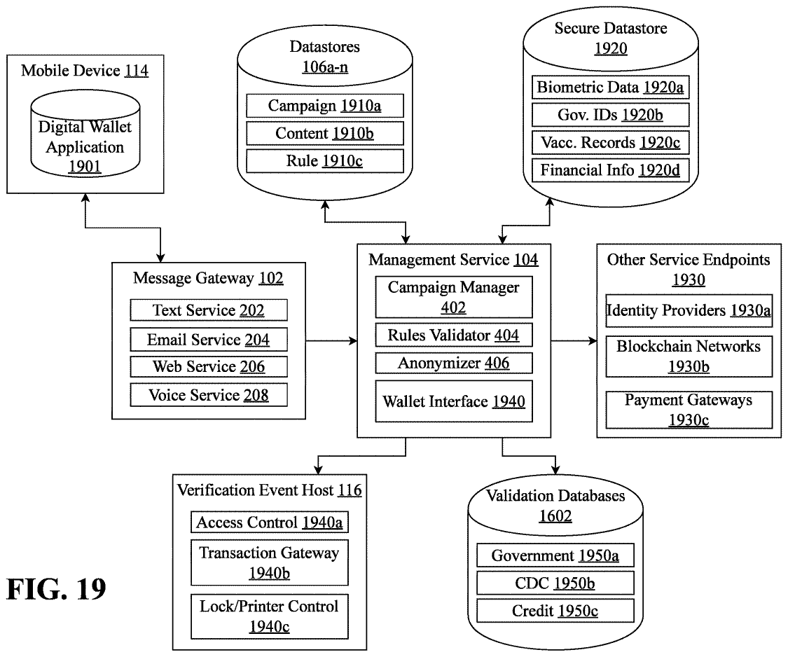

FIG. 19 is a block diagram illustrating an exemplary system architecture for a dynamic-link verification platform with AI-enhanced digital identity wallet integration. The system builds upon the core verification architecture previously described while introducing critical enhancements for secure credential storage, intelligent service integration, and privacy-preserving data management. At the user level, a Mobile Device 114 now incorporates a Digital Wallet Application 1901 that provides comprehensive identity management capabilities including secure local storage for verified credentials, cryptographic keys, and authentication tokens that the user has accumulated through various verification events. The Digital Wallet Application 1901 supports advanced privacy-preserving features including biometric authentication for secure access to stored credentials, zero-knowledge proofs that enable credential verification without revealing underlying data, selective disclosure mechanisms that allow users to reveal only specific attributes from credentials rather than complete credential contents, and credential delegation capabilities that permit users to authorize third parties to present credentials on their behalf. This local credential storage and sophisticated privacy architecture enables users to maintain control over their identity information and selectively present credentials as needed, rather than requiring each verification to query external databases.

The digital wallet architecture represents a significant advancement in user privacy and autonomy within verification systems. By storing credentials locally in the Digital Wallet Application 1901 on the Mobile Device 114, users gain the ability to present previously-verified attributes without requiring real-time database queries that might leak information about their activities to third parties. The wallet may store various types of credentials including government-issued identity tokens, health records, membership credentials, and transaction histories. The zero-knowledge proof capabilities enable the wallet to cryptographically prove possession of valid credentials or demonstrate that certain attributes meet specified requirements (such as proving age is over 21 without revealing exact birthdate) without necessarily revealing the underlying data or requiring the verifying party to contact the credential issuer. The selective disclosure features allow fine-grained control over information sharing, enabling scenarios where a user might prove their residential address to one verifier while proving their age to another, both from the same government-issued credential, without either verifier learning the information disclosed to the other. Credential delegation supports use cases where a user needs to authorize an agent, family member, or automated system to present credentials on their behalf, with cryptographic proof of the delegation relationship. This architecture supports emerging standards for verifiable credentials and decentralized identity, enabling users to aggregate verified identity attributes from multiple sources into a unified, user-controlled credential portfolio.

The security architecture of the Digital Wallet Application 1901 implements multiple layers of protection to ensure that stored credentials remain secure even if the Mobile Device 114 is compromised, lost, or stolen. At the foundation, the wallet leverages hardware-backed secure enclaves available on modern mobile platforms, such as the Secure Enclave Processor (SEP) on Apple devices or the Trusted Execution Environment (TEE) on Android devices. These hardware security modules provide isolated execution environments that are physically separated from the main application processor and operating system, ensuring that cryptographic operations and sensitive data processing occur in a protected space that cannot be accessed even by privileged system software or malware with root/administrator access. The Digital Wallet Application 1901 stores all private cryptographic keys within this secure enclave, where they are generated using hardware random number generators and are marked as non-exportable, meaning the keys can be used for cryptographic operations but cannot be extracted from the secure hardware even by the wallet application itself.

Credential data stored by the Digital Wallet Application 1901 is encrypted at multiple levels to provide defense in depth. At the device level, credentials are encrypted using AES-256-GCM (Galois/Counter Mode) with keys derived from the secure enclave's master key, ensuring that credentials are encrypted at rest and cannot be accessed if device storage is physically removed or if backups are compromised. At the application level, each credential is additionally encrypted with a credential-specific key that is itself encrypted by a key derived from user biometric authentication, implementing a cryptographic binding between the credential and the authorized user that prevents credential access even if the device encryption is somehow bypassed. This multi-layer encryption scheme ensures that credential data is protected by multiple independent cryptographic barriers, and that compromise of any single layer still leaves credentials protected by the remaining layers.

The biometric authentication implementation in the Digital Wallet Application 1901 follows security best practices to ensure that biometric data itself remains secure while providing strong authentication. The wallet does not store actual biometric images or templates in application-accessible storage; instead, it relies on the secure enclave's biometric authentication capabilities where biometric templates are stored in hardware-protected memory and matching operations occur entirely within the secure enclave. When a user attempts to access credentials, the Digital Wallet Application 1901 requests biometric authentication from the secure enclave, which prompts the user for fingerprint, face recognition, or other biometric input. The secure enclave performs the matching internally and returns only a success or failure result to the wallet application, along with a cryptographic authentication token signed by the secure enclave's attestation key. This token proves that biometric authentication occurred successfully without exposing any biometric data, and the wallet uses this token to derive keys needed to decrypt credential-specific encryption layers. The biometric authentication also implements liveness detection to prevent spoofing attacks using photographs, recordings, or artificial replicas, and includes attempt limiting where repeated failed biometric authentication attempts result in increasing delays or fallback to alternative authentication methods.

The zero-knowledge proof implementation in the Digital Wallet Application 1901 enables sophisticated privacy-preserving credential presentations. The wallet supports multiple zero-knowledge proof systems depending on the requirements of different credential types and verifiers, including zk-SNARKs (Zero-Knowledge Succinct Non-Interactive Arguments of Knowledge) for efficient proofs with small proof sizes, zk-STARKs (Zero-Knowledge Scalable Transparent Arguments of Knowledge) for proofs that don't require trusted setup, and Sigma protocols for simpler attribute proofs. When a credential is issued to the wallet, it includes not only the credential data and issuer signature but also a cryptographic commitment to the credential attributes and zero-knowledge proof parameters that enable future attribute proofs. When a verifier requests proof of a specific attribute (for example, “prove age is over 21”), the Digital Wallet Application 1901 generates a zero-knowledge proof using the credential commitment and the user's private key from the secure enclave, creating a cryptographic proof that the committed credential contains an age attribute greater than 21, without revealing the actual age value or any other attributes from the credential. The proof includes the issuer's signature on the credential commitment, proving the credential is authentic, along with a proof that the prover knows the opening of the commitment (possesses the actual credential) and that the committed attributes satisfy the requested predicate. This proof can be verified by the requesting party using only the issuer's public key and the proof itself, without requiring the issuer to be contacted or the credential to be revealed.

The selective disclosure capability allows even more flexible privacy-preserving presentations where the user chooses exactly which attributes to reveal from a credential. This is implemented through a combination of cryptographic techniques including Merkle tree commitments and signature schemes with efficient redaction. When a credential is issued, its attributes are organized into a Merkle tree structure where each leaf represents a single attribute, and the root of the tree is signed by the issuer. The Digital Wallet Application 1901 stores both the complete credential and the Merkle tree structure. When presenting the credential with selective disclosure, the wallet reveals only the requested attributes along with the Merkle proofs (the sibling nodes in the tree needed to recompute the root), enabling the verifier to confirm that the revealed attributes were part of the original signed credential without learning anything about the non-revealed attributes. Alternative implementations use BBS+ signatures or other signature schemes that natively support selective disclosure, where a single signature from the issuer covers all attributes but the signature can be transformed into a new signature that covers only a selected subset of attributes while remaining verifiable against the issuer's public key.

Credential delegation mechanisms in the Digital Wallet Application 1901 enable sophisticated authorization scenarios while maintaining security and auditability. When a user wishes to delegate credential presentation authority to another party, the wallet generates a delegation credential that cryptographically binds the authorization to specific constraints including which credentials may be presented by the delegate, what attributes from those credentials may be disclosed, what verifiers the delegate may present credentials to, time validity windows during which the delegation is active, and whether the delegation may be further sub-delegated. This delegation credential is itself a verifiable credential signed by the user's key from their secure enclave, and it includes a public key for the delegate that will be used to authenticate presentations made under the delegation. When the delegate presents a credential on the user's behalf, they must present both the underlying credential and the delegation credential, and verifiers validate both the original issuer's signature on the credential and the user's signature on the delegation, confirming that the delegate is authorized to present this specific credential data. The delegation credentials support revocation, where the user can publish revocation notices to the Distributed Ledger or other revocation registries that invalidate delegations before their normal expiration, ensuring users maintain control even after delegation occurs.

The Digital Wallet Application 1901 implements secure backup and recovery mechanisms to protect against device loss while maintaining the security of stored credentials. Rather than backing up credentials to cloud storage where they might be vulnerable to provider breaches or government access requests, the wallet uses a split-key backup scheme where credential encryption keys are split into multiple shares using Shamir's Secret Sharing or similar threshold cryptography. Some key shares are stored in encrypted form on the user's device (protected by the device's secure enclave), other shares are stored with trusted contacts designated by the user (encrypted such that the contacts cannot access the share data), and optionally additional shares may be stored with the federation infrastructure (again in encrypted form). Recovery requires reconstructing a threshold number of shares, such as any 3 out of 5 shares, meaning the user can lose access to some shares (device destroyed, contact unavailable) while still being able to recover. This approach ensures that no single entity including the wallet provider, federation, or any individual trusted contact can unilaterally access the user's credentials, while still providing robust recovery capabilities.

The Message Gateway 102 comprises multiple service modules including Text Service 202, Email Service 204, Web Service 206, and Voice Service 208, enabling communication across various channels as previously described. The Message Gateway 102 communicates bidirectionally with the Mobile Device 114 to receive verification requests and return verification responses or content. The Management Service 104 includes a Campaign Manager 402 for managing verification campaigns, a Rules Validator 404 for enforcing verification policies, an Anonymizer 406 for privacy protection, and a newly introduced Wallet Interface 1940 that specifically handles interactions with digital wallet applications. The Wallet Interface 1940 provides the necessary protocols and APIs for requesting credential presentations from the user's Digital Wallet Application 1901, validating cryptographic proofs including zero-knowledge proofs and selective disclosure presentations, verifying credential delegation authorities and checking delegation constraints, and coordinating wallet-based authentication flows that may involve biometric verification on the mobile device. The Wallet Interface 1940 implements the verifier role in credential presentation protocols, generating presentation requests that specify exactly what attributes or predicates are required, what credential types and issuers are acceptable, and what cryptographic proof formats are supported, and then validating the responses received from the Digital Wallet Application 1901 to confirm that credentials are authentic, current (not expired or revoked), properly presented (with valid zero-knowledge proofs or selective disclosure), and that any delegation chains are valid and within their authorized scopes.

The system now incorporates a bifurcated data storage architecture that separates general operational data from highly sensitive credential information. The standard Datastores 106a-n contain Campaign 1910a, Content 1910b, and Rules 1910c information related to verification events, initiators, and business logic as previously described. However, the system introduces a distinct Secure Datastore 1920 specifically designed for storing sensitive credential data with enhanced security measures. The Secure Datastore 1920 is architecturally and logically separated from the general-purpose datastores to provide additional layers of encryption, access control, and audit logging appropriate for handling personally identifiable information and regulated data types. The Secure Datastore 1920 employs hardware security modules (HSMs) for key management, ensuring that encryption keys protecting sensitive data are generated, stored, and used within tamper-resistant hardware that provides physical security protections. Data stored in the Secure Datastore 1920 is encrypted using envelope encryption where each data object is encrypted with a unique data encryption key (DEK), and the DEKs are themselves encrypted with key encryption keys (KEKs) managed by the HSM, ensuring that compromise of any single encryption key affects only a limited amount of data.

The Secure Datastore 1920 stores Biometric Data 1920a such as fingerprints, facial recognition templates, or iris scans used for strong authentication, though in accordance with security best practices, actual biometric templates are stored only when necessary for verification purposes that cannot be served by device-local biometric authentication, and when stored, they are protected by additional cryptographic transformations that prevent the raw biometric data from being reconstructed. Government IDs 1920b including passport information, driver's licenses, and national identity documents are stored in encrypted form with audit logging that records every access to these particularly sensitive identity documents, ensuring accountability and enabling detection of unauthorized access or data breaches. Vaccination Records 1920c such as immunization histories and health certificates are stored in compliance with healthcare privacy regulations including HIPAA, with access controls that ensure only authorized healthcare providers and verification systems can access this data, and with cryptographic assurance that records cannot be tampered with. Financial Information 1920d including payment credentials, credit history, and transaction records are stored in compliance with PCI-DSS (Payment Card Industry Data Security Standard) requirements when payment card data is involved, with tokenization applied where possible to replace sensitive payment credentials with non-sensitive tokens that can be used for verification without exposing actual account numbers or cryptographic materials. This separation ensures that even if the general operational databases are compromised, the most sensitive user credentials remain protected within the hardened Secure Datastore 1920 environment, and that different categories of sensitive data can be subject to category-appropriate security controls and compliance requirements.

The architecture further incorporates Other Service Endpoints 1930 that expand the verification platform's integration capabilities beyond traditional verification databases. These endpoints enable the verification system to interact with modern identity and transaction infrastructure. Identity Providers 1930a allow integration with federated identity systems using protocols such as OAuth, SAML, and OpenID Connect, enabling users to leverage existing identity credentials from social networks, enterprise directories, or government identity providers. When integrating with Identity Providers 1930a, the Wallet Interface 1940 can request credential issuance directly into the user's Digital Wallet Application 1901, converting identity assertions from OAuth or SAML protocols into verifiable credentials that the wallet can store and present independently, enabling users to obtain credentials from identity providers and then present them offline or to verifiers that don't have direct integration with those providers. Blockchain Networks 1930b provide connectivity to decentralized identifier (DID) resolution services and verifiable credential registries operating on distributed ledger technologies, enabling verification of credentials issued within blockchain-based identity ecosystems and validation of zero-knowledge proofs and selective disclosure presentations that may be anchored to blockchain-based credential schemas. The integration with Blockchain Networks 1930b enables the verification platform to resolve DIDs to DID documents containing public keys and service endpoints, to check credential revocation lists published on-chain, and to verify proof-of-existence for credentials using blockchain timestamps. Payment Gateways 1930c facilitate integration with financial transaction processors and payment networks, enabling verification events that require payment authorization or financial identity verification. These service endpoints communicate with the Management Service 104 to provide additional verification capabilities and credential sources beyond the traditional Validation Databases 1602.

The Validation Databases 1602 comprise Government 1950a databases for official identity verification, CDC 1950b databases for health-related verifications, and Credit 1950c databases for financial identity verification. The Verification Event Host 116 includes Access Control 1940a mechanisms for physical or logical access management, Transaction Gateway 1940b for completing authorized transactions, and Lock/Printer Control 1940c for actuating physical devices such as door locks, turnstiles, or badge printers based on verification results. The complete system architecture illustrated in FIG. 19 thus provides a comprehensive verification platform that combines traditional database verification with modern digital wallet technology featuring advanced privacy-preserving capabilities through hardware-backed secure enclaves and multi-layer encryption, zero-knowledge proofs and selective disclosure that enable attribute verification without data exposure, biometric authentication with liveness detection and secure enclave protection, flexible credential delegation with cryptographic authorization chains, secure backup and recovery using threshold cryptography, AI-enhanced interfaces, secure credential storage with defense-in-depth encryption and HSM-based key management, and extensive integration capabilities enabling sophisticated verification workflows that respect user privacy while maintaining strong security and enabling seamless access to federated services through flexible credential presentation mechanisms.

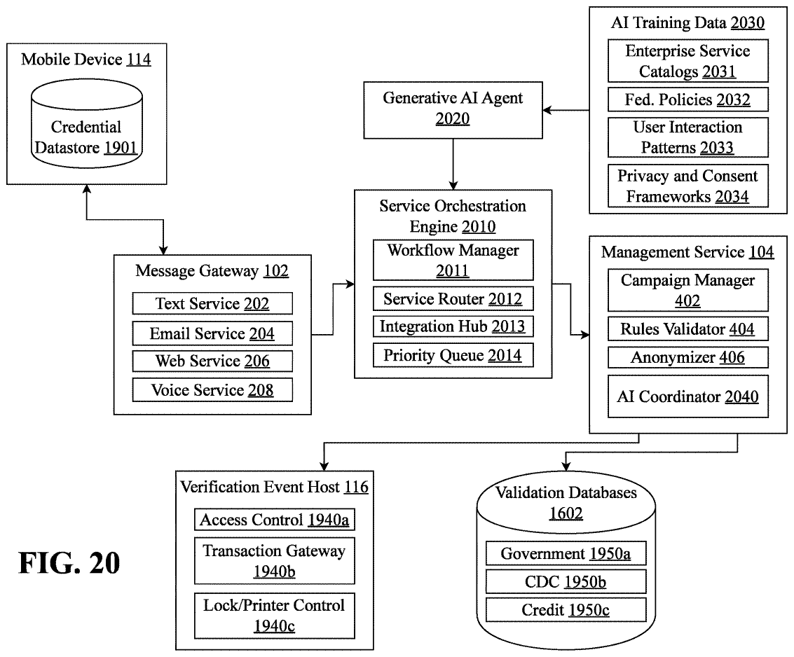

FIG. 20 is a block diagram illustrating an exemplary system architecture with intelligent user experience layer incorporating generative AI and service orchestration capabilities. The system architecture builds upon the verification platform by introducing artificial intelligence components that fundamentally transform how users interact with verification services, moving from static, rule-based interactions to dynamic, conversational experiences that adapt to user needs and context. The intelligent user experience layer enables the system to understand natural language requests, provide guidance through complex multi-step verification processes, explain trust relationships and requirements in plain language, and proactively suggest optimal service paths based on user intent and available credentials.

At the heart of the intelligent user experience layer is a Generative AI Agent 2020 that serves as an intelligent intermediary between users and the verification infrastructure. The Generative AI Agent 2020 employs advanced natural language processing and machine learning techniques to interpret user requests, understand verification requirements, and generate contextually appropriate responses and guidance. Unlike traditional rule-based systems that can only respond to predefined commands, the Generative AI Agent 2020 can engage in open-ended dialogue with users, answer questions about verification processes, explain why certain credentials are required, suggest alternative verification paths when primary methods are unavailable, and provide real-time assistance with credential management and presentation. The AI agent maintains conversation context across multiple interactions, enabling it to remember user preferences, track the progress of complex multi-step verification workflows, and provide personalized recommendations based on the user's verification history and available credentials. This conversational interface dramatically reduces user friction and confusion, particularly for complex verification scenarios that might involve multiple enterprises, various credential types, and nuanced trust requirements.

The Generative AI Agent 2020 is implemented using a large language model architecture that has been specifically fine-tuned for identity verification and federated service access scenarios. The base model may be a transformer-based architecture such as GPT, BERT, or similar neural network designs that have demonstrated strong natural language understanding and generation capabilities. However, rather than using a general-purpose language model directly, the Generative AI Agent 2020 undergoes extensive domain-specific training to specialize it for verification-related tasks and to ensure it provides accurate, policy-compliant guidance. The training process occurs in multiple stages, beginning with continued pre-training on a large corpus of verification-related documents including privacy regulations (GDPR, CCPA, HIPAA), identity verification standards and specifications, federated identity protocols, credential formats and schemas, and documentation of verification best practices. This continued pre-training allows the model to develop deep understanding of verification concepts, terminology, and regulatory requirements that may not be well-represented in general internet text used to train base language models.

Following continued pre-training, the model undergoes supervised fine-tuning using carefully curated training datasets derived from the AI Training Data 2030 repositories. The supervised fine-tuning process trains the model to respond appropriately to user queries by learning from examples of correct interactions. Training examples are constructed that demonstrate proper responses to common user questions such as “What credentials do I need to access this service?”, “Why is this verification failing?”, “How can I prove my age without revealing my birthdate?”, and numerous variations of these and other verification-related queries. Each training example consists of a user query or conversation context paired with an appropriate assistant response that correctly explains the verification requirements, suggests specific actions the user should take, references relevant policies or trust relationships, and maintains appropriate tone and clarity. The training dataset includes both successful verification scenarios and error cases, ensuring the model learns to provide helpful guidance when things go wrong, not just when they succeed.

The supervised fine-tuning process incorporates techniques to ensure the Generative AI Agent 2020 provides responses that are not only helpful but also factually accurate and policy-compliant. The model is trained with explicit fact-grounding, where responses must be supported by specific information from the Enterprise Service Catalogs 2031, Federation Policies 2032, or other authoritative sources rather than being generated purely from the model's parametric knowledge. During training, examples include retrieval steps where the model is shown how to query relevant knowledge sources and incorporate retrieved information into responses, implementing a retrieval-augmented generation (RAG) architecture. This ensures that when the AI agent tells a user what credentials are needed for a service, it is referencing the actual current service requirements rather than potentially outdated information learned during training. The fine-tuning also includes negative examples demonstrating incorrect or harmful responses that the model should avoid, such as responses that suggest circumventing verification requirements, that hallucinate non-existent services or capabilities, that provide inconsistent guidance across similar queries, or that fail to respect user privacy by asking for unnecessary information.

To further improve response quality and safety, the Generative AI Agent 2020 undergoes reinforcement learning from human feedback (RLHF), where human evaluators rate model responses according to multiple criteria including accuracy (does the response correctly reflect current policies and service requirements), helpfulness (does the response adequately address the user's question and guide them toward their goal), safety (does the response avoid suggesting policy violations or privacy-compromising actions), consistency (does the response align with responses to similar queries), and clarity (is the response understandable to users without technical expertise). These human ratings are used to train a reward model that can automatically score model responses, and this reward model is then used in reinforcement learning where the Generative AI Agent 2020 is optimized to generate responses that receive high scores from the reward model. The RLHF process is particularly important for ensuring the AI agent learns appropriate behavior for ambiguous situations where there may not be a single correct response but where some responses are clearly more helpful or safer than others.

The Generative AI Agent 2020 is supported by comprehensive AI Training Data 2030 that provides the knowledge base necessary for intelligent operation. The training data comprises several critical categories of information that enable the AI to function effectively within the verification ecosystem. Enterprise Service Catalogs 2031 contain structured information about all services available across the federated network, organized in a machine-readable format that the AI can efficiently query and reason about. Each service entry in the catalog includes the service name and description in natural language, the enterprise or enterprises that provide the service, specific verification requirements that must be satisfied to access the service specified as formal logic expressions over credential attributes, alternative verification paths that may satisfy the requirements through different combinations of credentials, expected processing times and service availability schedules, costs or fees associated with the service, user eligibility criteria beyond verification requirements (such as geographic restrictions or membership prerequisites), and links to detailed documentation. The Enterprise Service Catalogs 2031 are structured using ontologies and semantic schemas that enable the AI to understand relationships between services, such as which services are prerequisites for other services, which services provide similar functionality and might serve as alternatives, and which services can be combined to accomplish complex user goals.

Federation Policies 2032 encode the rules, trust relationships, and policy frameworks that govern federated verification operations in a format that enables both human understanding and machine reasoning. These policies are represented using formal policy languages such as XACML (eXtensible Access Control Markup Language) or Rego (used by Open Policy Agent) that can express complex authorization rules, combined with natural language annotations that explain the intent and implications of each policy in terms the AI can use when generating explanations for users. The Federation Policies 2032 include inter-enterprise trust policies specifying which enterprises' credentials are accepted by which other enterprises and under what conditions, privacy policies detailing what user data may be collected, retained, and shared in various verification scenarios, consent requirements specifying when explicit user consent is needed before credential sharing can occur, data retention and deletion policies governing how long verification records are maintained, credential validation policies specifying requirements for credential freshness, issuer signatures, revocation checking, and other security properties, delegation policies defining what types of credential delegation are permitted and what constraints apply, and dispute resolution policies outlining processes for handling disagreements about verification outcomes or policy interpretations. The AI training process includes learning to navigate these policy structures, to identify which policies are relevant to a given user query, and to explain policy implications in understandable terms.

User Interaction Patterns 2033 capture common workflows, frequent user questions, typical verification sequences, and successful interaction patterns learned from historical data. This component of the training data is continuously updated through analysis of actual user interactions with the system, implementing a feedback loop where the AI learns from experience. The User Interaction Patterns 2033 are derived through several analytical processes including conversation mining where successful user interactions are analyzed to identify common patterns such as typical question sequences users follow when trying to access a new service, effective explanation strategies that lead to successful credential presentations, common points of confusion where users need additional guidance, and successful resolution patterns for verification errors. The patterns also include intent classification models trained on historical queries that enable the AI to quickly recognize what users are trying to accomplish even when expressed in varied or ambiguous language, entity recognition models that identify mentions of specific services, enterprises, credential types, or verification requirements within user queries, and dialogue state tracking models that maintain understanding of conversation context across multiple turns, remembering what service the user is asking about, what credentials they've mentioned having, and what options have already been discussed.

The User Interaction Patterns 2033 training data is carefully processed to remove personally identifiable information before being used in AI training, ensuring that the AI learns from aggregate patterns of user behavior without memorizing specific users' sensitive information. Techniques such as differential privacy are applied during pattern extraction, adding calibrated noise to usage statistics and pattern frequencies to prevent the training data from revealing information about any individual user's verification activities. The patterns are also temporally weighted, with more recent interactions having greater influence on the AI's behavior than older historical data, ensuring the AI adapts to evolving user expectations and changing service offerings rather than being locked into outdated interaction models.

Privacy and Consent Frameworks 2034 ensure that the AI agent understands and respects privacy regulations, consent requirements, and data protection principles when guiding users through credential sharing decisions or explaining verification requirements. The training data includes comprehensive representations of relevant privacy regulations encoded in both formal logic for machine reasoning and natural language for explanation generation. Each privacy regulation is decomposed into specific requirements that the AI must respect, such as the GDPR's principles of purpose limitation (data collected for one purpose cannot be used for another without new consent), data minimization (only the minimum necessary personal data should be collected), storage limitation (personal data should not be retained longer than necessary), and the rights of data subjects including rights to access, rectification, erasure, and data portability. The AI is trained to proactively inform users about these rights during verification interactions and to guide users in exercising their rights when requested.

The Privacy and Consent Frameworks 2034 include consent decision trees that model complex consent scenarios, enabling the AI to understand when consent is required, what information must be provided to users to make consent informed, what granularity of consent should be offered (whether users can consent to sharing some attributes while withholding others), and how long consent remains valid. The AI is trained to generate consent requests that are clear and specific, explaining exactly what data will be shared, with whom it will be shared, for what purpose, and how long it will be retained, rather than using vague or overly broad consent language. The frameworks also include training on consent withdrawal, ensuring the AI can guide users through revoking previously granted consents and understands the implications of consent withdrawal on service access.

The training data also incorporates privacy-enhancing techniques training, where the AI learns to proactively suggest privacy-preserving alternatives when appropriate. For example, when a user asks how to verify their age for a service, the AI is trained to first consider whether zero-knowledge age proofs from the user's Digital Wallet Application 1901 could satisfy the requirement rather than immediately suggesting disclosure of birthdate or government ID. The AI learns a privacy preference ordering where techniques that reveal less information are preferred over those that reveal more, guiding users toward selective disclosure, zero-knowledge proofs, and other privacy-enhancing approaches when they can satisfy verification requirements.

The training process for the Generative AI Agent 2020 implements several important safeguards to prevent the AI from being manipulated into providing harmful guidance or circumventing security controls. Adversarial training is incorporated where the model is exposed to examples of users attempting to manipulate it into revealing information it shouldn't, suggesting ways to bypass verification requirements, or providing guidance that would violate policies. The model is trained to recognize these adversarial queries and respond with appropriate refusals while still being helpful in explaining why the requested action cannot be supported. The training also includes alignment techniques that ensure the AI's objectives remain focused on helping users accomplish legitimate verification goals while respecting all security and privacy constraints, rather than simply maximizing user satisfaction which might incentivize the AI to suggest policy-violating shortcuts.

The AI training infrastructure implements continuous monitoring and updating processes to ensure the Generative AI Agent 2020 remains accurate and effective as the federation evolves. When new services are added to Enterprise Service Catalogs 2031, new enterprises join the federation with updated trust relationships in Federation Policies 2032, or new interaction patterns emerge in User Interaction Patterns 2033, the training data is updated and the model undergoes incremental fine-tuning to incorporate this new knowledge. This continuous learning process uses techniques such as elastic weight consolidation or progressive neural networks that enable learning new information while preserving previously learned knowledge, avoiding catastrophic forgetting where the model loses its understanding of older services or policies when trained on new data. The continuous training process is carefully governed to ensure that model updates are validated before deployment, with automated testing that verifies the updated model still provides correct responses to a suite of test queries covering all critical verification scenarios and that no performance degradation has occurred on existing capabilities.

The Generative AI Agent 2020 implements runtime safeguards in addition to training-time protections. Before generating a response to a user query, the AI consults the current state of Enterprise Service Catalogs 2031 and Federation Policies 2032 to retrieve up-to-date information relevant to the query, implementing a retrieval-augmented generation approach that grounds responses in current facts rather than relying solely on parametric knowledge from training. The AI's generated responses pass through policy compliance checkers that verify the response doesn't suggest actions that would violate federation policies, reveal information the AI shouldn't have access to, or provide guidance inconsistent with current trust relationships and service requirements. If a policy violation is detected, the response is rejected and regenerated with additional constraints. The AI also implements uncertainty estimation, where it assesses its confidence in the information it's providing and includes appropriate caveats when uncertainty is high, directing users to consult authoritative documentation or human support when the AI cannot confidently answer a query.

The Service Orchestration Engine 2010 works in concert with the Generative AI Agent 2020 to translate high-level user intents into concrete verification workflows spanning potentially multiple enterprises and services. While the AI agent handles natural language understanding and user interaction, the Service Orchestration Engine 2010 manages the technical coordination of verification processes across the system. The Service Orchestration Engine 2010 comprises several specialized components that enable sophisticated workflow management. A Workflow Manager 2011 designs and executes multi-step verification processes, determining the optimal sequence of credential requests, database queries, and service invocations required to fulfill a user's verification needs while minimizing redundant checks and respecting inter-service dependencies. The Workflow Manager 2011 receives high-level goals from the Generative AI Agent 2020 (such as “user wants to access service X which requires credentials Y and Z”) and translates these into executable workflows that coordinate actions across the Message Gateway 102, Management Service 104, and various service endpoints. A Service Router 2012 implements intelligent routing logic that selects appropriate service endpoints based on factors including service availability, response time, cost, trust level requirements, and user preferences, enabling the system to dynamically adapt to changing conditions and optimize performance. An Integration Hub 2013 provides standardized interfaces and protocol translation for communicating with diverse external services, enabling the orchestration engine to seamlessly coordinate actions across verification databases, identity providers, blockchain networks, payment gateways, and other service endpoints regardless of their underlying protocols or APIs. A Priority Queue 2014 manages concurrent verification requests, implementing sophisticated scheduling algorithms that balance factors such as user service level agreements, request urgency, resource availability, and fairness across multiple simultaneous users.

The Mobile Device 114 maintains a local Credential Datastore 1901 as in the previous architecture, enabling wallet-based credential presentation. The Message Gateway 102 continues to provide multi-channel communication through Text Service 202, Email Service 204, Web Service 206, and Voice Service 208. Notably, in this architecture the Message Gateway 102 communicates not only directly with the Management Service 104 but also with the Generative AI Agent 2020, enabling the AI to intercept and process incoming user messages before they reach the core verification logic. This architecture allows the AI agent to handle informational queries, provide guidance, and reformulate or enrich user requests before passing them to the verification system, significantly enhancing the user experience while reducing load on the core verification infrastructure. When messages are routed to the Generative AI Agent 2020, the AI analyzes the message to determine user intent, maintains conversation state across multiple message exchanges, generates natural language responses using the techniques and training described above, and when appropriate, formulates verification requests to pass to the Service Orchestration Engine 2010 for execution.

The Management Service 104 is augmented with an AI Coordinator 2040 module that serves as the interface between the traditional verification infrastructure and the intelligent user experience layer. The AI Coordinator 2040 manages interactions between the Campaign Manager 402, Rules Validator 404, and Anonymizer 406 components and the Generative AI Agent 2020 and Service Orchestration Engine 2010. The AI Coordinator 2040 translates between the structured, rule-based world of verification campaigns and the dynamic, intent-driven world of AI-orchestrated workflows, ensuring that AI-driven verification processes still comply with all relevant rules, policies, and privacy requirements. When the Service Orchestration Engine 2010 executes a workflow based on AI-interpreted user intent, the AI Coordinator 2040 ensures that each step is validated against campaign rules and policies by the Rules Validator 404, that any personally identifiable information is properly handled by the Anonymizer 406 when required, and that the overall process aligns with the campaign configuration managed by the Campaign Manager 402. The AI Coordinator 2040 also provides feedback to the AI Training Data 2030, capturing successful verification patterns, user interaction outcomes, and system performance metrics that enable continuous improvement of the AI agent's capabilities. This feedback loop includes recording which AI-suggested verification paths successfully completed, which encountered errors or user difficulties, which privacy-preserving techniques users preferred when offered choices, and how accurately the AI predicted user intents, enabling the training data to be enriched with real-world outcomes that improve future AI performance.

The Service Orchestration Engine 2010 communicates with the Management Service 104 to coordinate verification workflows and with the Generative AI Agent 2020 to receive high-level intent information and provide status updates that the AI can communicate to users in natural language. The bidirectional communication between the AI agent and orchestration engine enables sophisticated collaborative workflows where the AI handles user interaction and intent understanding, the orchestration engine handles technical execution and coordination across systems, and status information flows back to the AI enabling it to provide users with real-time updates on verification progress, explain any delays or issues that arise, and suggest corrective actions when verifications encounter problems. The system continues to utilize Validation Databases 1602 comprising Government 1950a, CDC 1950b, and Credit 1950c data sources for traditional verification queries. The Verification Event Host 116 includes Access Control 1940a, Transaction Gateway 1940b, and Lock/Printer Control 1940c components that execute the physical or logical actions resulting from successful verification.

The complete intelligent user experience architecture illustrated in FIG. 20 thus transforms the verification platform from a transactional system requiring users to navigate complex technical requirements into an intelligent assistant that understands user needs expressed in natural language, provides guidance and explanation grounded in current service catalogs and federation policies, orchestrates complex multi-service workflows while maintaining policy compliance, learns continuously from user interactions to improve future performance, respects privacy through training on privacy frameworks and runtime policy checking, handles conversation context and multi-turn dialogues to support complex verification scenarios, proactively suggests privacy-enhancing verification alternatives when appropriate, and delivers seamless access to federated verification services through natural, conversational interactions supported by sophisticated AI training processes including continued pre-training on domain-specific content, supervised fine-tuning with fact-grounding and retrieval augmentation, reinforcement learning from human feedback for safety and helpfulness, adversarial training to prevent manipulation, and continuous learning with safeguards against catastrophic forgetting.

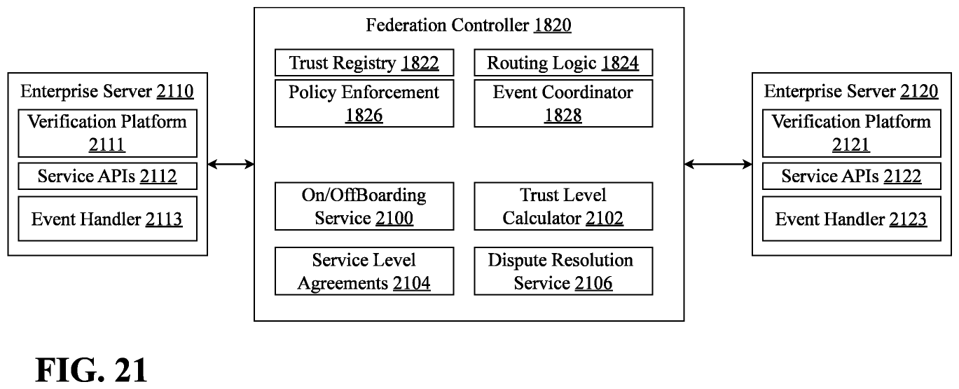

FIG. 21 is a block diagram illustrating an exemplary detailed architecture of a federation controller with enterprise management functions for coordinating verification services across federated enterprises. The diagram focuses on the internal structure and operational components of the Federation Controller 1820 and its interactions with Enterprise Servers participating in the federated network. The Federation Controller 1820 serves as the central coordination point for all federated verification activities, managing the complex relationships, trust calculations, service agreements, and dispute resolution processes necessary to enable multiple independent enterprises to collaborate effectively while maintaining their autonomy and protecting their business interests.

The Federation Controller 1820 comprises both core operational modules and specialized enterprise management functions that together enable sophisticated federated operations. The core operational modules include the Trust Registry 1822, which maintains authoritative records of each participating enterprise's trust level, verification capabilities, credential types they are authorized to issue, and their standing within the federation. The Routing Logic 1824 implements intelligent algorithms for directing verification requests to appropriate enterprise nodes based on factors including service type, geographic location, current load, trust requirements, and service level agreements. The Policy Enforcement 1826 module ensures that all federated transactions comply with federation-wide policies as well as individual enterprise policies, intercepting and validating requests before they are processed to ensure compliance with privacy regulations, data sharing agreements, and business rules. The Event Coordinator 1828 orchestrates complex verification events that may span multiple enterprises, managing the sequencing of requests, coordinating parallel verification activities, aggregating results from multiple sources, and ensuring transactional consistency across enterprise boundaries.

Beyond these core operational capabilities, the Federation Controller 1820 incorporates four critical enterprise management functions that govern the lifecycle and quality of federated relationships. The On/Offboarding Service 2100 manages the complete lifecycle of enterprise participation in the federation, from initial registration through active operation to eventual departure. During onboarding, this service handles enterprise registration, credential provisioning for federation access, configuration of trust relationships with existing federation members, integration testing to ensure compatibility with federation protocols, and establishment of initial trust scores based on verification of the enterprise's credentials and capabilities. The onboarding process may involve multiple verification steps including validation of business licenses, review of security practices, assessment of verification capabilities, and approval by existing federation members or federation governance bodies. During offboarding, the service manages the graceful removal of enterprises from the federation, including revocation of federation credentials, notification of dependent services, migration of active verification sessions to alternative providers, and archival of historical transaction records for audit purposes. The On/Offboarding Service 2100 ensures that the federation maintains high quality standards for participation while providing clear and efficient processes for enterprises to join or leave the network.

The Trust Level Calculator 2102 implements sophisticated algorithms for computing and continuously updating trust scores for each participating enterprise based on their behavior, performance, and compliance within the federation. Trust levels are not static attributes but rather dynamic scores that reflect an enterprise's ongoing reliability and adherence to federation standards. The Trust Level Calculator 2102 monitors multiple factors when assessing enterprise trust, including verification accuracy rates (comparing verification outcomes against subsequent discoveries of fraud or error), service availability and uptime statistics, response time performance and adherence to service level commitments, compliance with federation policies and data protection regulations, user satisfaction ratings and complaint frequency, security incident history and response effectiveness, and participation in federation governance and improvement initiatives. The trust calculation algorithms may employ machine learning techniques to identify patterns associated with reliable versus problematic enterprise behavior, enabling predictive assessment of trust levels. Trust scores directly influence how the federation operates: enterprises with higher trust levels may receive more verification requests through the Routing Logic 1824, may be authorized to issue more valuable or sensitive credentials, may participate in governance decisions, and may receive preferential terms in service agreements. Conversely, enterprises whose trust scores decline may face increased monitoring, restrictions on credential types they may issue, reduced routing priority, or ultimately suspension or removal from the federation.

The Service Level Agreements 2104 module manages the performance commitments and quality standards that govern federated operations. Service level agreements in a federated context must address multiple dimensions of service quality across organizational boundaries. The module maintains agreements specifying maximum response times for verification requests, minimum uptime and availability requirements, acceptable error rates and verification accuracy thresholds, data retention and deletion timelines, security and privacy protection standards, incident response and notification requirements, and compensation or remediation terms for service failures. The Service Level Agreements 2104 module continuously monitors actual performance against these commitments, collecting metrics from transaction logs, user feedback, and system monitoring data. When performance deviates from agreed levels, the module may trigger various responses including automated notifications to the responsible enterprise, adjustment of routing logic to direct traffic away from underperforming services, initiation of penalty or compensation processes defined in the agreements, escalation to dispute resolution processes for significant or repeated violations, and adjustment of trust scores through the Trust Level Calculator 2102 to reflect performance issues. The module also supports negotiation and modification of service level agreements as enterprises' capabilities evolve, federation requirements change, or new service types are introduced to the network.

The Dispute Resolution Service 2106 provides critical governance capabilities for managing conflicts and disagreements that inevitably arise in complex multi-party systems. Disputes in federated verification may arise from numerous sources including disagreements about verification outcomes where one enterprise questions another's verification decision, allegations of policy violations or improper data handling, performance disputes related to service level agreement compliance, billing or compensation disagreements for federated services, trust score disputes where an enterprise challenges their calculated trust level, user complaints about privacy violations or improper credential usage, and conflicts between federation policies and individual enterprise requirements. The Dispute Resolution Service 2106 implements structured processes for addressing these conflicts, providing escalation paths from automated resolution for simple disputes through mediation by federation administrators to formal arbitration for significant conflicts. The service maintains detailed records of all disputes, their resolution processes, and outcomes, creating precedents that inform future policy development and help prevent recurring conflicts. Resolution outcomes may result in trust score adjustments, policy clarifications or modifications, service level agreement amendments, compensation payments, or in severe cases, enterprise suspension or expulsion from the federation.

The Federation Controller 1820 communicates bidirectionally with multiple Enterprise Servers, illustrated as Enterprise Server 2110 and Enterprise Server 2120, representing the plurality of enterprises participating in the federation. Each Enterprise Server comprises a Verification Platform 2111, 2121 that implements the core verification logic specific to that enterprise, Service APIs 2112, 2122 that provide programmatic interfaces for submitting verification requests and retrieving results, and Event Handlers 2113, 2123 that manage the asynchronous processing of verification events and coordinate with the Federation Controller 1820. The bidirectional communication between the Federation Controller 1820 and Enterprise Servers enables the controller to route verification requests to appropriate enterprises, collect verification results and status updates, monitor enterprise performance and availability, synchronize policy and trust relationship updates, and coordinate multi-enterprise verification workflows.

The architecture illustrated in FIG. 21 thus provides a comprehensive federation management infrastructure that goes beyond simple request routing to encompass the full lifecycle of enterprise relationships, continuous trust assessment, rigorous service quality management, and formal dispute resolution processes. This sophisticated governance infrastructure is essential for enabling multiple independent organizations with potentially competing business interests to collaborate effectively in providing verification services, ensuring that the federation maintains high quality standards, protects user privacy and security, provides accountability and recourse when issues arise, and creates sustainable economic incentives for enterprises to participate and contribute to the federated ecosystem. The Federation Controller 1820 thereby serves not merely as a technical coordination point but as the governance backbone that makes truly federated identity verification operationally and economically viable.

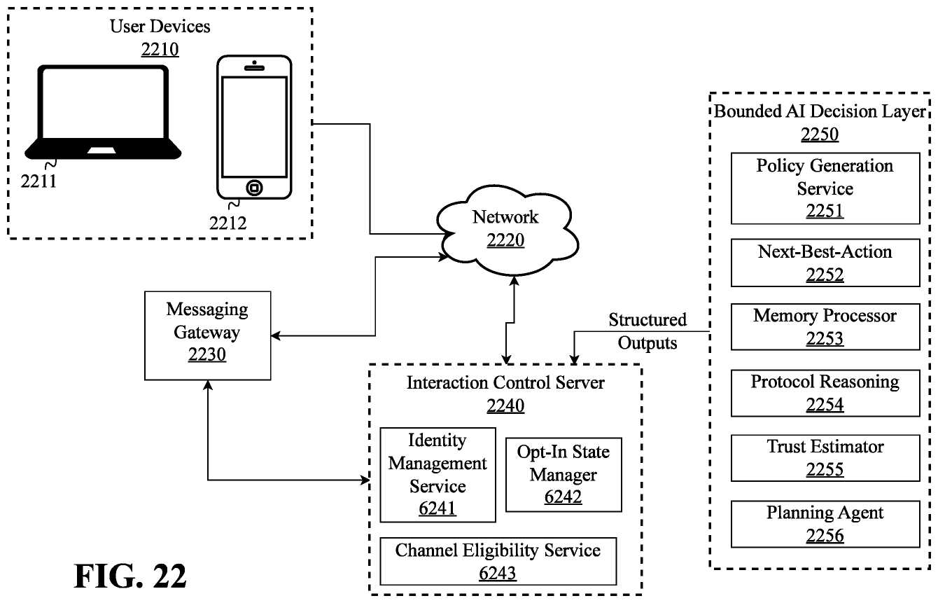

FIG. 22 is a block diagram illustrating an exemplary system architecture for intelligent interaction control incorporating bounded artificial intelligence decision components. The architecture introduces a bounded AI decision layer that operates as an advisory intelligence component rather than a direct user-facing conversational agent, enabling adaptive engagement behavior while maintaining deterministic control over message execution, protocol usage, and regulatory compliance.

The system comprises user devices 2210, which may include desktop computers 2211, mobile devices 2212, or other computing devices capable of engaging with digital activation assets and exchanging messages over communication networks. User devices 2210 communicate via network 2220, which may comprise the Internet, cellular networks, Wi-Fi networks, or combinations thereof.

A messaging gateway 2230 serves as the protocol mediation layer, handling message transmission and reception across multiple communication protocols including SMS, MMS, and RCS. The messaging gateway 2230 performs protocol translation, fallback operations, and delivery coordination but does not make autonomous decisions regarding engagement behavior or policy compliance. Instead, the messaging gateway 2230 receives explicit instructions from interaction control server 2240 regarding what messages to send, which protocols to use, and how to handle delivery failures.

The interaction control server 2240 serves as the central coordination point for all engagement activities. The interaction control server 2240 receives user interactions via the messaging gateway 2230, manages session state, coordinates with various subsystem components, and makes final determinations regarding what engagement actions will be executed. The interaction control server 2240 enforces all opt-in constraints, policy requirements, and regulatory compliance rules before any message is transmitted or routing action is performed.

Within the interaction control server 2240, an identity management service 6241 maintains persistent user identity profiles anchored to communication identifiers such as phone numbers. The identity management service 6241 accumulates interaction history, stores user preferences, maintains engagement context across multiple sessions and campaigns, and provides identity-anchored data to other system components. This identity continuity enables the system to recognize returning users, retrieve prior interaction context, and apply personalized engagement policies without requiring users to re-authenticate or re-establish their preferences with each interaction.

An opt-in state manager 6242 captures, stores, and evaluates user consent states governing permissible messaging behavior and protocol eligibility. The opt-in state manager 6242 enforces hard constraints on system behavior, ensuring that no engagement action proceeds without valid user consent. All recommendations or outputs generated by artificial intelligence components are evaluated against opt-in state by the interaction control server 2240, and any recommendations that would violate consent boundaries are blocked regardless of their source.

A channel eligibility service 6243 determines which communication protocols and messaging affordances are available and permissible for a given user interaction. The channel eligibility service 6243 evaluates device capabilities, carrier support, protocol registration status, and business rule constraints to establish what communication channels may be used. The channel eligibility service 6243 imposes hard constraints that override any protocol recommendations generated by artificial intelligence components.

The system further comprises a bounded AI decision layer 2250, which functions as an advisory intelligence component that generates structured control outputs consumed by deterministic system components. The bounded AI decision layer 2250 does not transmit messages, does not communicate with users, and does not override compliance constraints. Instead, it enhances system intelligence by generating policies, recommending actions, processing interaction history, and reasoning about protocol usage in ways that inform but do not control final system behavior.

Within the bounded AI decision layer 2250, a policy generation service 2251 produces structured engagement and personalization policies that guide how the interaction control server 2240 conducts user interactions. The policy generation service 2251 operates on identity profile data, interaction history, opt-in state information, and campaign context to generate policy objects encoding permitted message types, suppressed content categories, timing constraints, escalation thresholds, and protocol preferences. Policy objects are versioned, timestamped, and associated with confidence levels. Policy objects may persist across sessions and campaigns, enabling policy reuse and continuity across multiple interaction contexts. The policy generation service 2251 continuously revises and updates policies over time as additional interaction data becomes available, with policy evolution occurring incrementally through confidence-weighted adjustments based on observed user behavior.

A next-best-action component 2252 implements agentic decision logic that selects appropriate system actions from a predefined action space. The next-best-action component 2252 evaluates current session state, applicable policy objects, interaction memory, opt-in state, and protocol capabilities to recommend what engagement action should occur next. The next-best-action component 2252 outputs structured action identifiers or tokens rather than generating free-form content, ensuring that all recommended actions correspond to known, supported system behaviors. The action space may include initiating delivery of an informational message, requesting clarification or qualification from a user, deferring engagement for a specified period, suppressing engagement due to inferred disinterest or redundancy, escalating the interaction to a human agent, routing the interaction to an automated downstream service, modifying protocol usage or interaction modality, and terminating or pausing an interaction session.

A memory processor 2253 transforms raw interaction logs into compact, reusable memory objects that summarize salient aspects of prior user engagements. The memory processor 2253 analyzes historical messages, response patterns, accepted or declined offers, answered questions, and engagement timing to generate structured memory representations. These memory objects are associated with identity profiles maintained by the identity management service 6241, enabling cross-campaign continuity and suppression of redundant engagement. Memory objects may include indications of questions already answered by the user, content or offers that have been declined, engagement patterns such as preferred interaction timing, unresolved interaction states requiring follow-up, and inferred engagement dispositions. Memory objects are identity-anchored rather than campaign-specific, enabling memory reuse across multiple campaigns and interaction contexts.

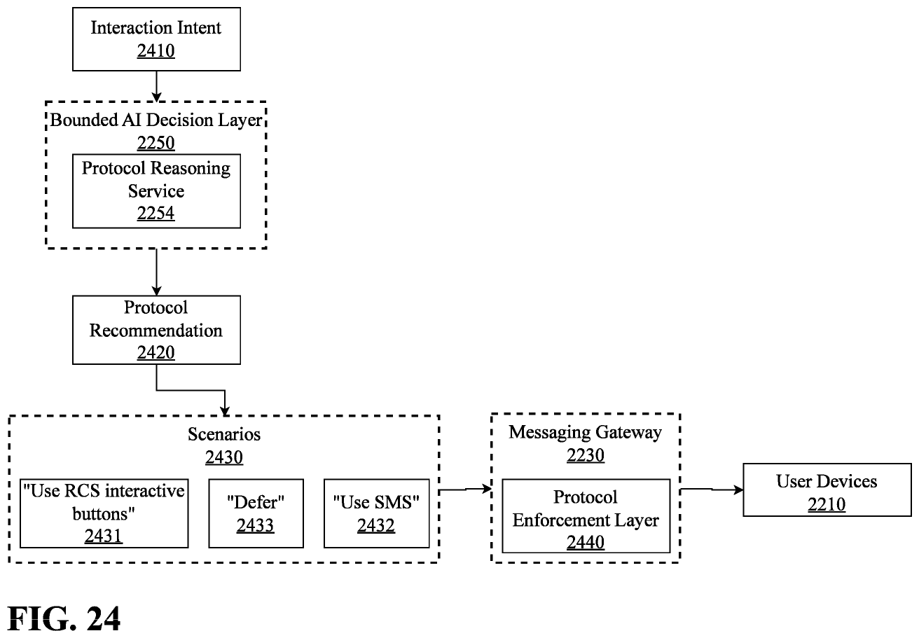

A protocol reasoning component 2254 evaluates communication protocol affordances and generates structured recommendations regarding protocol usage. The protocol reasoning component 2254 assesses whether specific protocol capabilities such as interactive buttons, rich media presentation, or structured responses are required or beneficial for a given interaction. The protocol reasoning component 2254 considers interaction intent, device capabilities, historical delivery outcomes, user responsiveness patterns, and session continuity requirements when generating protocol recommendations. Protocol recommendations are advisory only; the messaging gateway 2230 and channel eligibility service 6243 enforce actual protocol selection and apply fallback behavior when recommended protocols are unavailable, as further illustrated in FIG. 24.

A trust estimator 2255 generates structured assessments of user engagement disposition based on interaction patterns, response behaviors, and historical outcomes. The trust estimator 2255 evaluates signals such as response latency, completeness of user responses, acceptance or rejection of prior engagement, protocol usage patterns, and session continuity to produce readiness and trust indicators representing inferred user willingness to continue or deepen engagement. These indicators are expressed as categorical states, bounded levels, or weighted signals suitable for consumption by other system components. The trust estimator 2255 does not alter opt-in state or independently gate messaging; rather, its outputs inform policy generation, action selection, and protocol reasoning performed by other components within the bounded AI decision layer 2250.

A planning agent 2256 generates bounded, short-horizon engagement plans comprising ordered sequences of candidate engagement steps. The planning agent 2256 operates on session state, policy objects, memory objects, and readiness indicators to produce structured plans defining what actions may be attempted if specified conditions are satisfied. Engagement plans are intentionally limited in scope and duration to prevent uncontrolled or overly speculative interaction sequences. The interaction control server 2240 evaluates and executes plan steps deterministically, enforcing all applicable policies, opt-in constraints, and protocol eligibility rules before executing any step. Plans may be revised, skipped, or terminated based on intervening user behavior or changing system conditions.

A critical architectural feature illustrated in FIG. 22 is the unidirectional flow of structured outputs from the bounded AI decision layer 2250 to the interaction control server 2240. This flow is labeled “Structured Outputs” to emphasize that AI components generate only structured control objects such as policy objects, action identifiers, memory representations, protocol recommendations, readiness indicators, and engagement plans. The bounded AI decision layer 2250 does not generate message text, does not initiate communications with users, and does not execute engagement actions. All execution occurs through the interaction control server 2240, which evaluates AI-generated outputs against opt-in state, channel eligibility, and system policies before taking any action.

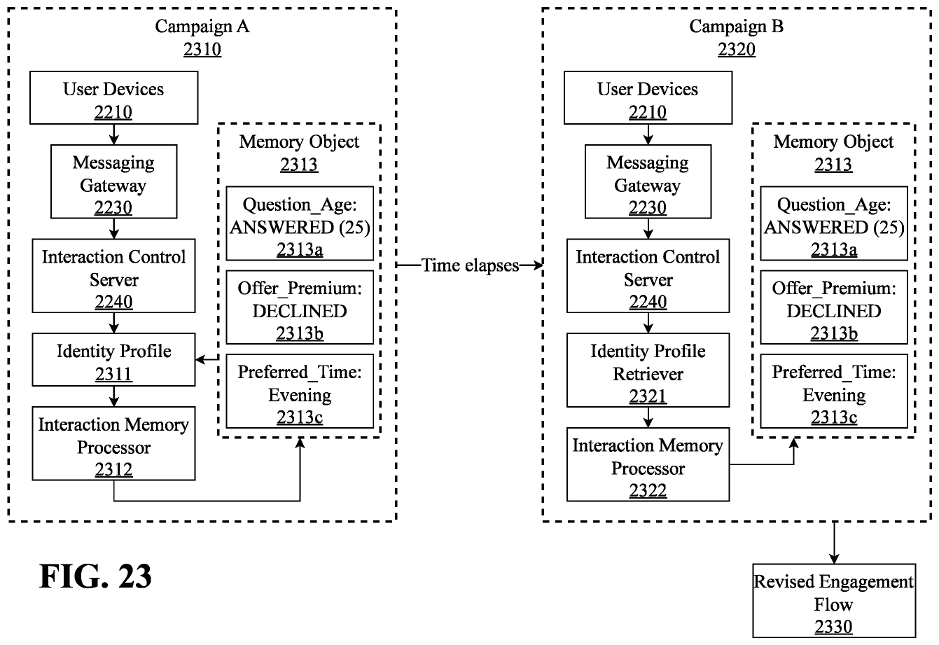

FIG. 23 is a block diagram illustrating an exemplary interaction memory processing flow and cross-campaign continuity mechanism enabled by identity-anchored memory objects. The diagram depicts two temporally separated engagement scenarios, campaign A 2310 and campaign B 2320, demonstrating how interaction history accumulated during an initial campaign is preserved, retrieved, and applied during subsequent campaigns to suppress redundant engagement and maintain personalized interaction context. This cross-campaign memory capability represents a significant advancement over conventional engagement systems that treat each campaign as an isolated interaction context, forcing users to repeatedly provide the same information and subjecting them to redundant qualification questions across different marketing initiatives or service interactions.

In campaign A 2310, a user initiates an engagement using user devices 2210, which may comprise mobile devices, desktop computers, or other communication-enabled computing devices. The user interaction is transmitted via messaging gateway 2230 to interaction control server 2240. The interaction control server 2240 processes the incoming interaction and coordinates with various subsystem components to determine appropriate engagement behavior.

During the campaign A interaction, the interaction control server 2240 retrieves or creates an identity profile 2311 associated with the user's communication identifier. The identity profile 2311 serves as a persistent repository of user-specific data maintained by the identity management service 6241 as disclosed in FIG. 22. The identity profile 2311 accumulates interaction context, preferences, and engagement history across multiple sessions and campaigns, enabling the system to recognize returning users and apply personalized treatment without requiring repeated authentication or preference specification.

As the campaign A interaction progresses, an interaction memory processor 2312 analyzes the interaction flow and generates a memory object 2313 that encodes salient aspects of the engagement. The interaction memory processor 2312 corresponds to the memory processor 2253 disclosed in FIG. 22. The memory object 2313 comprises structured data elements that summarize what information has been exchanged with the user, what questions have been asked and answered, what offers or content have been presented, and what user responses or behaviors have been observed.

In the illustrated example, the memory object 2313 includes several specific data elements capturing interaction outcomes from campaign A. A question_age field 2313a records that the user's age question has been ANSWERED with a value of 25, indicating that the user has already provided age information during this interaction and need not be asked again in future engagements. An offer_premium field 2313b records that a premium service offer has been DECLINED by the user, indicating that similar premium offers should be suppressed in subsequent interactions to avoid subjecting the user to repeated presentations of unwelcome content. A preferred_time field 2313c records that the user has demonstrated engagement preference for evening timing, enabling future interactions to be scheduled or delivered during time windows when the user is most likely to be receptive.

The memory object 2313 is stored in association with the identity profile 2311, creating a persistent, identity-anchored record of the campaign A interaction that will remain available for consultation during future engagement scenarios. This identity-anchored storage approach enables memory reuse across campaigns, activation assets, and interaction contexts without requiring campaign-specific configuration or manual exclusion list management.

Following the completion of campaign A 2310, a period of time elapses as indicated by the “Time elapses” annotation connecting the two campaign scenarios. This temporal separation may represent days, weeks, or months during which the user does not interact with the system. During this period, the memory object 2313 remains associated with the identity profile 2311 and available for retrieval when the user next engages with the system.

In campaign B 2320, which represents a subsequent and distinct engagement initiative potentially related to different products, services, or marketing objectives, the same user again initiates interaction using user devices 2210. The interaction is transmitted via messaging gateway 2230 to interaction control server 2240 using the same architectural components and communication flows as campaign A.

A critical distinction in campaign B is that the interaction control server 2240 now retrieves an identity profile retriever 2321 (which may be the same logical profile as 2311 but is shown with a distinct reference number to emphasize the retrieval operation in the second campaign context) and discovers the previously stored memory object 2313. Because the memory object 2313 is identity-anchored rather than campaign-specific, it remains accessible and relevant even though campaign B represents a different engagement context than campaign A.

The interaction memory processor 2322 (corresponding to the same logical component as 2312 but operating in the campaign B context) evaluates the memory object 2313 to determine what interaction history should inform the current engagement. By consulting the memory object 2313, the system discovers that question_age 2313a has already been ANSWERED, that offer_premium 2313b has been DECLINED, and that preferred_time 2313c indicates evening preference.

Based on this memory-informed context, the interaction control server 2240 modifies its engagement behavior to suppress redundant interactions and respect previously established preferences. Specifically, the system avoids re-asking the age question that was already answered in campaign A, suppresses any premium service offers similar to those previously declined, and schedules or prioritizes campaign B messaging for evening time windows when the user has demonstrated engagement preference. This memory-driven adaptation occurs without requiring manual configuration of exclusion rules or campaign-specific suppression logic.

The result of this memory-informed processing is a revised engagement flow 2330 that differs from what would have occurred in the absence of interaction memory. The revised engagement flow 2330 represents the modified interaction sequence implemented by the interaction control server 2240 after applying memory-based suppressions and personalizations. This revised flow may skip certain qualification questions, avoid presenting declined offer types, apply preferred timing constraints, or otherwise adapt the engagement to reflect accumulated knowledge of the user's preferences and prior interactions.

The memory objects generated and applied in FIG. 23 are dynamic and subject to revision. If subsequent user behavior contradicts prior memory assumptions, the interaction memory processor 2312 or 2322 may weaken, revise, or remove corresponding memory elements. For example, if the user later accepts a premium offer after having previously declined such offers, the offer_premium field 2313b may be updated to reflect changing preferences, ensuring that memory-driven adaptations remain responsive to evolving user disposition rather than permanently constraining engagement based on outdated assumptions.

The identity-anchored memory architecture further operates subject to opt-in scope and privacy constraints enforced by the opt-in state manager 6242 as disclosed in FIG. 22. Memory objects may be filtered, redacted, or limited in scope based on consent parameters, and users may be provided with mechanisms to view, modify, or delete stored memory objects in accordance with privacy regulations such as GDPR's right to erasure or CCPA's data access requirements.

FIG. 24 is a block diagram illustrating an exemplary AI-assisted protocol capability reasoning process that enables granular, context-aware selection of communication protocols and messaging affordances. The diagram demonstrates how the disclosed system moves beyond conventional binary channel selection logic—where protocols such as RCS are treated as monolithic capabilities that are either fully enabled or entirely bypassed—to implement nuanced reasoning about which specific protocol features are appropriate for particular interaction contexts. This granular affordance evaluation capability represents a significant technical advancement that improves delivery effectiveness, reduces unnecessary protocol complexity, and enables selective use of enhanced messaging capabilities based on interaction requirements and user responsiveness patterns.

The protocol reasoning process begins with an interaction intent 2410, which represents the purpose or objective of a proposed engagement action. The interaction intent 2410 may comprise structured data specifying what information needs to be communicated, what user responses are desired, what interactive elements are required, and what urgency or delivery constraints apply. In the illustrated example, the interaction intent 2410 might specify objectives such as “deliver appointment confirmation with rescheduling options,” “present product information with purchase capability,” or “request qualification information with structured response options.” The interaction intent 2410 serves as input to the protocol reasoning process, enabling the system to evaluate protocol selection based on the specific requirements of the intended interaction rather than applying uniform protocol policies across all message types.

The interaction intent 2410 is provided to a protocol reasoning service 2254, which operates within the bounded AI decision layer 2250 as disclosed in FIG. 22. Unlike conventional protocol selection logic that evaluates only device capability and carrier support, the protocol reasoning service 2254 performs multi-factor analysis considering interaction-specific requirements, historical delivery outcomes, user engagement patterns, and contextual constraints.

The protocol reasoning service 2254 evaluates several categories of input when generating protocol recommendations. First, it assesses what communication affordances are required or beneficial for the interaction intent 2410, such as whether interactive buttons or action elements are necessary, whether rich media presentation would enhance comprehension, whether structured response formats are needed, or whether basic text delivery is sufficient. Second, it evaluates device capabilities and protocol support associated with the target user devices 2210, determining what protocols are technically available. Third, it analyzes historical success rates for different protocols based on prior delivery outcomes, user responsiveness, and engagement patterns stored in interaction memory objects as disclosed in FIG. 23. Fourth, it considers delivery constraints such as network conditions, latency requirements, or session continuity needs. Fifth, it may incorporate trust and readiness indicators from the trust estimator 2255 component of the bounded AI decision layer 2250 as disclosed in FIG. 22, using engagement disposition assessments to inform whether enhanced protocol capabilities are likely to be effective for the current user state.

Based on this multi-factor evaluation, the protocol reasoning service 2254 generates a protocol recommendation 2420 comprising structured guidance regarding protocol usage for the current interaction. The protocol recommendation 2420 is not an executable instruction but rather an advisory output that will be evaluated by deterministic enforcement components before any protocol selection occurs. The protocol recommendation 2420 may specify preferred protocols, indicate which specific affordances should be utilized, suggest fallback preferences, and include confidence indicators reflecting the strength of evidence supporting the recommendation.

The protocol recommendation 2420 feeds into a set of alternative scenarios 2430 representing different possible protocol selection outcomes based on the reasoning analysis. These scenarios illustrate the range of recommendations that may be generated by the protocol reasoning service 2254 depending on the specific combination of interaction requirements, device capabilities, historical patterns, and contextual factors evaluated.

Scenario 2431, labeled “Use RCS interactive buttons,” represents a recommendation to utilize enhanced RCS messaging capabilities including interactive action buttons or structured response elements. This scenario might be recommended when the interaction intent 2410 requires user selection among multiple options, when the target device supports RCS with interactive affordances, when historical data indicates the user engages effectively with RCS messages, and when trust and readiness indicators suggest the user is receptive to enhanced interaction modalities. The recommendation to use RCS interactive buttons reflects a determination that the full affordance capabilities of the enhanced protocol are both necessary for the interaction objectives and likely to be effective given user context.

Scenario 2432, labeled “Use SMS,” represents a recommendation to utilize baseline SMS messaging without enhanced protocol capabilities. This scenario might be recommended when the interaction intent 2410 can be adequately fulfilled through text-only communication, when device or carrier support for enhanced protocols is uncertain or unavailable, when historical data indicates the user responds more reliably to simple SMS messages, when delivery speed or reliability is prioritized over presentation richness, or when trust and readiness indicators suggest that enhanced affordances might create unwanted complexity. The recommendation to use SMS reflects a determination that baseline protocol capabilities are sufficient and that attempting to use enhanced protocols would not provide meaningful benefit or might introduce delivery risk.

Scenario 2433, labeled “Defer,” represents a recommendation to postpone the interaction rather than selecting a protocol for immediate delivery. This scenario might be recommended when trust and readiness indicators suggest low user receptiveness, when interaction memory objects indicate recent non-response or disengagement patterns, when timing constraints make immediate delivery suboptimal, or when contextual factors suggest that deferring engagement would improve eventual success likelihood. The recommendation to defer reflects a determination that protocol selection is less relevant than interaction timing, and that attempting immediate delivery regardless of protocol choice would likely be ineffective.

The three scenarios 2431, 2432, and 2433 collectively illustrate the range of protocol reasoning outcomes enabled by the disclosed system, demonstrating how the protocol reasoning service 2254 can recommend full use of enhanced protocols, selective use of baseline protocols, or deferral of engagement based on comprehensive contextual analysis. This multi-scenario capability moves beyond binary “RCS available/unavailable” logic to implement nuanced protocol selection that adapts to interaction requirements and user context.

The protocol recommendation 2420 and associated scenarios are transmitted to a messaging gateway 2230, which as disclosed in FIG. 22 and FIG. 23 handles actual message transmission across multiple communication protocols. Critically, the messaging gateway 2230 incorporates a protocol enforcement layer 2440 that implements deterministic protocol selection and delivery logic. The protocol enforcement layer 2440 represents the architectural separation between AI-generated protocol recommendations and actual protocol execution, ensuring that all protocol usage complies with eligibility rules, opt-in constraints, and technical requirements regardless of AI recommendations.

The protocol enforcement layer 2440 evaluates the protocol recommendation 2420 against hard constraints enforced by the channel eligibility service 6243 as disclosed in FIG. 22. If the protocol reasoning service 2254 recommends use of RCS interactive buttons but the channel eligibility service 6243 determines that RCS is unavailable, unsupported by the carrier, or prohibited by business rules, the protocol enforcement layer 2440 overrides the recommendation and applies appropriate fallback behavior such as delivering via SMS or MMS. Similarly, if the recommended protocol usage would violate opt-in constraints maintained by the opt-in state manager 6242, the protocol enforcement layer 2440 blocks or modifies the delivery accordingly.

The protocol enforcement layer 2440 also implements session continuity management and fallback handling. If initial delivery attempts using a recommended protocol fail due to network issues, carrier rejections, or device incompatibilities, the protocol enforcement layer 2440 automatically applies fallback protocols while preserving message content and interaction context. This fallback capability ensures reliable delivery even when preferred protocols prove unavailable at execution time.

Following protocol enforcement and any necessary fallback operations, the messaging gateway 2230 transmits the message to user devices 2210 using the finally selected protocol. The delivery outcome, including which protocol was actually used, whether fallback occurred, and how the user responded, is recorded and made available to the protocol reasoning service 2254 for use in future protocol recommendations. This feedback loop enables the protocol reasoning service 2254 to continuously improve its recommendations based on observed delivery outcomes and user engagement patterns.

The protocol reasoning process operates in coordination with other components of the bounded AI decision layer 2250 as disclosed in FIG. 22. Interaction memory objects generated by the memory processor 2253 inform protocol recommendations based on prior user responsiveness to different protocol types. Engagement policies generated by the policy generation service 2251 may restrict or prioritize certain protocol affordances. Trust and readiness indicators from the trust estimator 2255 influence whether enhanced protocol capabilities are likely to be effective. The next-best-action component 2252 may incorporate protocol recommendations when selecting engagement actions.

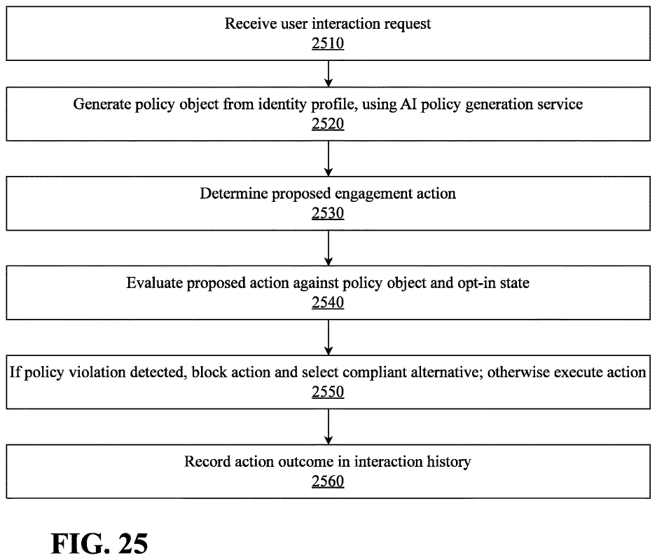

FIG. 25 is a flow diagram illustrating an exemplary method for policy-governed interaction control using artificial intelligence components, evaluates proposed actions against those policies, and enforces compliance through deterministic decision logic. The method depicted in FIG. 25 represents the dynamic interplay between bounded AI decision components and interaction control infrastructure, showing how AI-generated policy objects guide but do not override deterministic enforcement of opt-in constraints and regulatory requirements. This method embodies the core architectural principle of separating inference from execution, whereby artificial intelligence enhances system intelligence through advisory policy generation while deterministic components maintain ultimate control over messaging actions and compliance.

The method begins at step 2510 with receiving a user interaction request. This step corresponds to the reception of an inbound message, activation asset engagement, or other user-initiated communication via a messaging gateway that handles multiple communication protocols including SMS, MMS, and RCS. The user interaction request may originate from user devices such as mobile phones, tablets, or desktop computers and may comprise message content, user identifier information such as phone number or email address, interaction context such as campaign identifiers or activation asset references, and metadata describing the communication channel and protocol used. The reception of the user interaction request triggers the interaction control process and initiates retrieval of relevant user context needed for policy-informed decision making. The messaging gateway forwards the received interaction to an interaction control server that serves as the central coordination point for all engagement activities. The interaction control server parses the incoming request to extract user identifiers, determines whether the user has an existing identity profile in the system, and prepares to coordinate with various subsystem components to determine appropriate engagement behavior.

At step 2520, the system generates a policy object from an identity profile using an AI policy generation service. This step implements policy generation functionality that operates within a bounded AI decision layer comprising multiple specialized AI components that generate structured control outputs rather than directly communicating with users or executing messaging actions. The policy generation process operates on an identity profile associated with the user identifier received in the previous step. An identity management service maintains persistent user identity profiles anchored to communication identifiers, accumulating interaction history, prior engagement outcomes, inferred preferences, and contextual information across multiple sessions and campaigns. The AI policy generation service retrieves this accumulated data from the identity profile and applies machine learning techniques to generate a structured policy object. The policy object comprises structured data elements encoding engagement constraints and preferences derived from the user's historical behavior and interaction patterns. These elements may include permitted categories of messages or interaction types that are likely to be well-received based on prior user responses, suppressed or prohibited content classes that the user has previously declined or ignored, timing constraints reflecting observed engagement patterns such as preferred contact windows or minimum delay intervals between messages, escalation thresholds indicating when interactions should be routed to human agents based on complexity or user engagement disposition, protocol usage constraints specifying preferred or appropriate messaging affordances based on device capabilities and user responsiveness to different protocol types, and confidence or weighting indicators reflecting the strength of evidence supporting each policy element. The policy object is versioned and timestamped, enabling tracking of policy evolution over time. The policy generation service continuously revises and updates policies as additional interaction data becomes available, with policy evolution occurring incrementally through confidence-weighted adjustments based on observed user behavior. If user behavior contradicts existing policy assumptions, the policy generation service may weaken, revise, or revoke affected policy elements, allowing the system to adapt to changing user preferences without becoming locked into outdated assumptions.

At step 2530, the system determines a proposed engagement action based on the interaction context and available system capabilities. This step may be performed by the interaction control server in coordination with a next-best-action component that operates within the bounded AI decision layer. The proposed engagement action represents what the system intends to do in response to the user interaction request received in the first step. The proposed action may take various forms depending on interaction objectives, including sending an informational message providing requested content or service details, requesting additional qualification information to better understand user needs or eligibility, presenting an offer or call-to-action encouraging user conversion or transaction completion, escalating to a human agent when interaction complexity exceeds automated handling capabilities, routing to a downstream service endpoint such as a customer relationship management system or external API, or deferring engagement for later follow-up when immediate response is deemed suboptimal. The proposed action is determined based on multiple factors including the interaction intent derived from the user's request, campaign objectives associated with the activation asset or context that initiated the interaction, available content configured for the relevant campaign or service, routing logic that determines which destinations are appropriate for different interaction types, and AI-generated recommendations from the next-best-action component that evaluates current session state, applicable policy objects, interaction memory, opt-in state, and protocol capabilities to select an appropriate system action from a predefined action space. The next-best-action component outputs structured action identifiers or tokens rather than generating free-form content, ensuring that all recommended actions correspond to known, supported system behaviors. However, the proposed action at this stage has not yet been evaluated for policy compliance or opt-in constraint satisfaction, representing an intention that must be validated before execution.

At step 2540, the system evaluates the proposed action against the policy object generated in the second step and against opt-in state constraints maintained by an opt-in state manager component. This evaluation step represents the deterministic enforcement layer that ensures all engagement actions comply with both AI-generated personalization policies and hard regulatory constraints. The evaluation process examines multiple dimensions of compliance. First, it determines whether the proposed action falls within the permitted message categories specified by the policy object, checking that the action type aligns with inferred user preferences and prior engagement patterns. Second, it verifies whether the action involves content types that have been suppressed by the policy due to prior user disinterest, ensuring the system does not repeatedly present declined offers or unwelcome content. Third, it assesses whether the timing of the proposed action complies with timing constraints in the policy object, such as preferred contact windows derived from historical engagement patterns, and with any user-specified do-not-contact periods that may have been explicitly configured. Fourth, it determines whether the proposed action would exceed escalation thresholds or engagement frequency limits encoded in the policy, preventing overly aggressive or intrusive engagement behavior. Fifth, and critically, it evaluates whether the proposed action is permissible under the user's current opt-in state as maintained by the opt-in state manager, which captures, stores, and enforces user consent states governing permissible messaging behavior and protocol eligibility. The opt-in state manager enforces hard constraints on system behavior, ensuring that no engagement action proceeds without valid user consent, and all recommendations or outputs generated by artificial intelligence components are subordinate to these consent requirements. The evaluation implements a logical decision point that determines whether the proposed action may proceed as intended or must be blocked or modified. If the evaluation determines that the proposed action complies with both the policy object and opt-in state constraints, the method proceeds to execute the action as proposed. If the evaluation detects any policy violation or opt-in constraint violation, the method proceeds to block the action and select a compliant alternative. This evaluation step embodies the architectural principle that AI-generated policies guide but do not control system behavior, and that compliance with opt-in state and regulatory requirements takes precedence over any AI recommendations or proposed actions.

At step 2550, if a policy violation has been detected during the evaluation in the previous step, the system blocks the originally proposed action and selects a compliant alternative action that satisfies policy constraints. Alternatively, if no policy violation was detected, the system executes the originally proposed action as approved by the evaluation process. This conditional step embodies the deterministic enforcement principle that ensures adaptive, intelligent behavior remains compliant with opt-in state and regulatory requirements. When a policy violation is detected, the system may select from several categories of alternative actions depending on the nature of the violation and available compliant options. First, the system may defer the engagement action to a later time that complies with timing constraints, such as postponing a message intended for evening delivery when the policy specifies morning-only contact preferences based on observed user responsiveness patterns. This deferral maintains the interaction intent while respecting temporal preferences. Second, the system may modify the content or type of the engagement action while preserving the underlying interaction intent, such as sending an informational message instead of a promotional offer when promotional content is suppressed by the policy due to prior user declines. This content substitution enables continued engagement through alternative messaging approaches. Third, the system may reduce the intensity or intrusiveness of the engagement action, such as sending a text message instead of initiating a phone call when the policy indicates preference for less intrusive channels based on historical engagement patterns. This de-escalation maintains contact while respecting user preferences for communication modality. Fourth, the system may escalate the interaction to a human agent who can exercise judgment regarding how to proceed in a compliant manner, particularly when automated alternatives cannot adequately fulfill the interaction objectives while satisfying policy constraints. Fifth, the system may suppress the engagement action entirely if no compliant alternative can achieve the interaction objectives, prioritizing compliance over engagement completion. When no policy violation is detected and the proposed action is approved for execution, the system proceeds to transmit messages via the messaging gateway using appropriate communication protocols, update session state to reflect the current interaction status, route interactions to appropriate destinations such as human agents or downstream services including customer relationship management systems or external APIs, or perform other engagement actions as determined in the third step. The execution of approved actions implements deterministic messaging and routing capabilities, including protocol selection and enforcement through a protocol enforcement layer that evaluates protocol recommendations against channel eligibility constraints and applies fallback behavior when recommended protocols prove unavailable.

At step 2560, the system records the action outcome in the interaction history associated with the user's identity profile. This recording step updates the identity profile maintained by the identity management service with information about what action was executed, when the action occurred, whether the action was the originally proposed action or a compliant alternative selected due to policy violation, what user response if any was received following the action execution, and what engagement outcome resulted such as successful completion indicating the interaction achieved its objectives, user disengagement suggesting the interaction was ineffective or unwelcome, escalation to human agent reflecting a transition from automated to human-assisted handling, or other terminal states representing various interaction conclusions. The recorded action outcome becomes part of the interaction history that will inform future policy generation when the user next interacts with the system, implementing continuous learning and policy evolution capabilities. The recording may also trigger updates to interaction memory objects that are analyzed by an interaction memory processor to generate compact, reusable memory representations summarizing salient aspects of prior user engagements. The interaction memory processor transforms raw interaction logs into structured memory objects that may include indications of questions already answered by the user, content or offers that have been declined, engagement patterns such as preferred interaction timing or cadence, unresolved interaction states requiring follow-up, and inferred engagement dispositions. These memory objects are identity-anchored rather than campaign-specific, enabling memory reuse across multiple campaigns and interaction contexts to suppress redundant questions, avoid re-presenting declined offers, and maintain personalized interaction context without requiring manual configuration. The recorded outcomes also inform trust and readiness estimation processes that generate structured assessments of user engagement disposition based on interaction patterns, response behaviors, and historical outcomes, producing readiness and trust indicators that influence future engagement decisions. Through this recording and feedback mechanism, each interaction contributes to the system's evolving understanding of user preferences, improving the quality of future policy generation, action selection, and protocol reasoning while maintaining strict separation between AI-generated recommendations and deterministic enforcement of compliance constraints.

### Detailed Description of Exemplary Aspects

FIG. 6 is a block diagram illustrating exemplary content 600 that may be served 650/652 by a dynamic-link communication platform. Content that may be stored and served via a dynamic-link communication platform may comprise text 602, pictures 604, sound bites 606, videos 608, URLs 610, push notifications 612, location data 614, calendar invites 616, phone calls 618, download requests 620, application install request 622, and application initializations 624. Much of this content may be sent over MMS or other messaging services, attached to emails, or hosted in the cloud that may be linked in emails and texts, or hosted elsewhere and sent via URL's, among many other possible combinations known in the art.

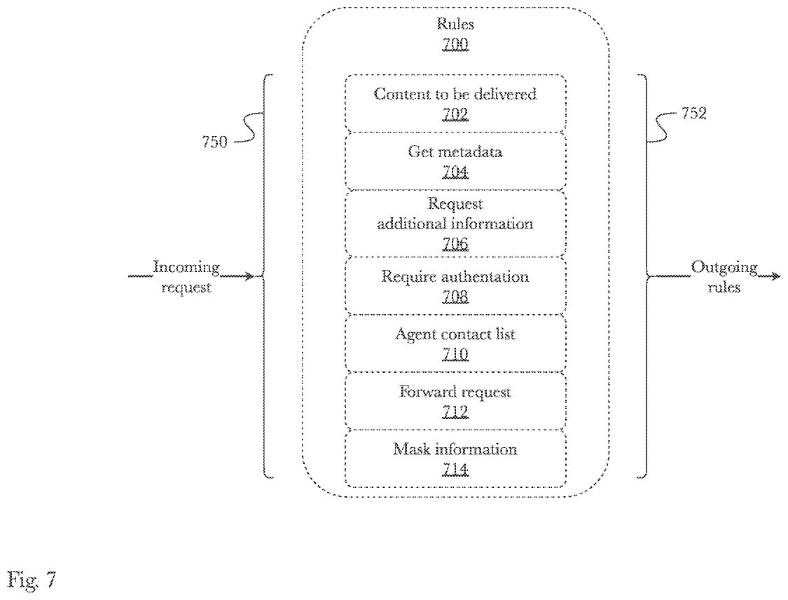

FIG. 7 is a block diagram illustrating exemplary rules 700 that may be used by a dynamic-link communication platform. A non-exhaustive list of exemplary rules 752 that may be used against an incoming request 750 comprises: what content may be delivered 702, what kind of metadata to retrieve from the device 704, whether or not to send subsequent messages to the device requesting additional information 706, and whether or not the content requires authentication 708. Rules may be an algorithm comprising a list of agents such that the algorithms perform a round-robin style query to find an available agent, and other like algorithms 710. Rules may simply forward messages to a system, device, or agent 712. Other rules may require that certain information be masked for privacy and regulatory compliance 714.

FIG. 8 is a block diagram illustrating exemplary initiators 108 used to facilitate dynamic-link communications. As illustrated by the diagram and the many initiator forms 802-814, it can be seen that an initiator 108 may take the form of anything that allows the user to interact 850 with the initiator 108 such that a device used to engage with the initiator can be commanded to auto-populate a message on the device 852. Tappable content on a mobile device or clickable links from a desktop for laptop computer may be used 802. Phone numbers on a printed advertisement can be dialed by the user in which an automated system on the other end of the line automatically responds with a text message to the calling device 804. QR codes are suited very well for this purpose as they may embed a plurality of information pertinent to efficient two-way communications 806. Another example may be a voice command that may be displayed to a user such that the user may say the voice command to a virtual assistant 808 on his or her device to initiate the communication. According to another embodiment, a purpose-built application for a dynamic-link communication platform may comprise its own virtual assistant and may also add increased functionality to a dynamic-link communication platform system. Advertisements embedded within applications and software programs 810, interactive voice response robocalls 812, and near field communication technologies 814 are all other examples that may be used as initiators 108.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

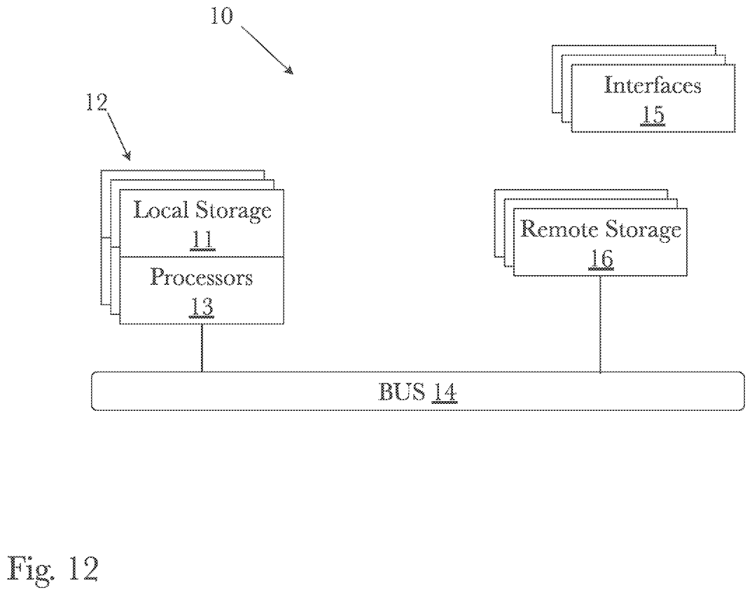

Referring now to FIG. 12, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software-or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 12 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

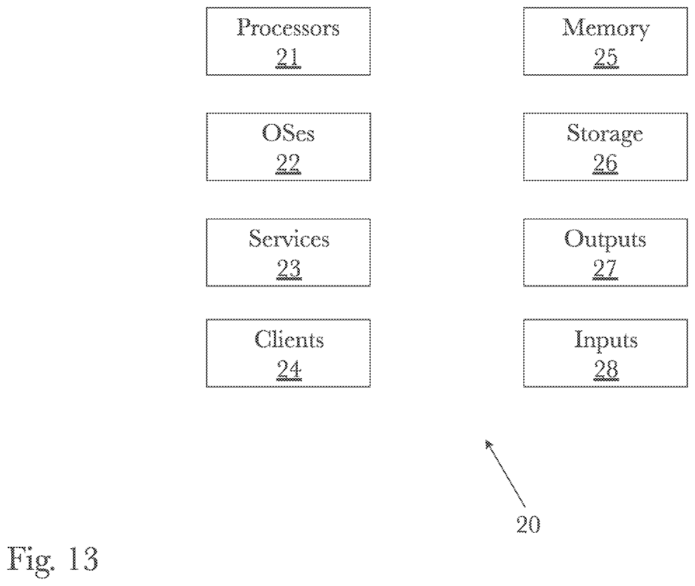

In some aspects, systems may be implemented on a standalone computing system. Referring now to FIG. 13, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 12). Examples of storage devices 26 include flash memory, magnetic hard drive, CD-ROM, and/or the like.

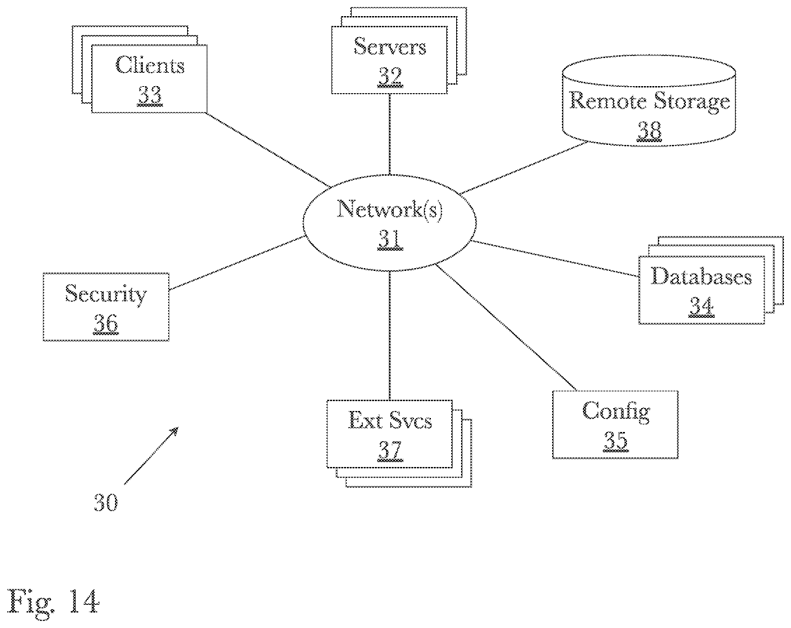

In some aspects, systems may be implemented on a distributed computing network, such as one having any number of clients and/or servers. Referring now to FIG. 14, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 13. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and using a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

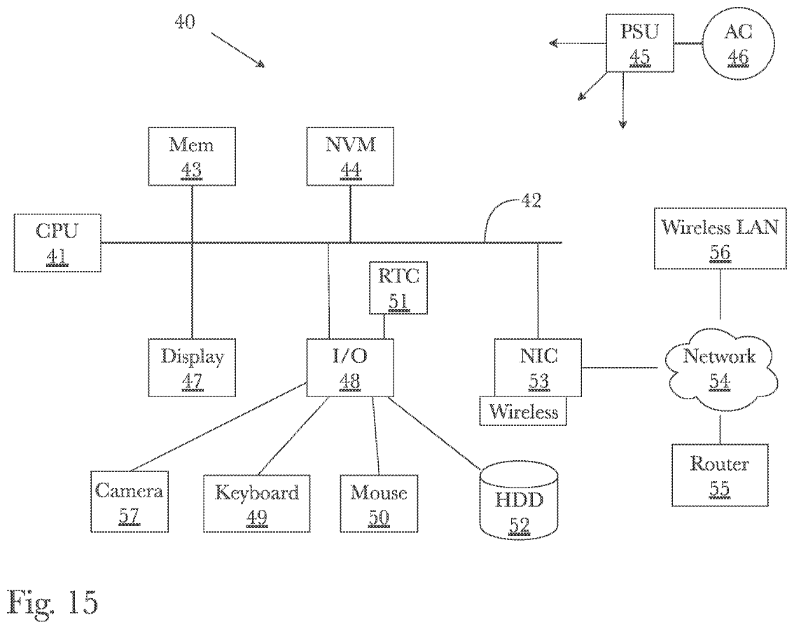

FIG. 15 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for intelligent interaction control with bounded artificial intelligence decision components, comprising:
an interaction control server configured to receive user interactions, manage session state, and coordinate engagement behavior;
a messaging gateway configured to transmit and receive messages over multiple communication protocols;
an identity management service configured to maintain persistent user identity profiles anchored to communication identifiers;
an opt-in state manager configured to capture and enforce user consent states governing permissible messaging behavior;
a bounded AI decision layer, comprising:
a policy generation service configured to generate structured policy objects from identity profiles, wherein policy objects encode permitted message types, suppressed content categories, and timing constraints;
a memory processor configured to generate interaction memory objects from interaction history, wherein memory objects are identity-anchored and reusable across multiple campaigns; and
a protocol reasoning service configured to generate protocol recommendations based on interaction intent and device capabilities;
wherein the interaction control server evaluates AI-generated outputs against opt-in state prior to executing messaging actions; and
wherein the system enables cross-campaign continuity through identity-anchored memory objects that suppress redundant engagement.

2. The system of claim 1, wherein the bounded AI decision layer further comprises a next-best-action component configured to select engagement actions from a predefined action space.

3. The system of claim 1, wherein the memory processor generates memory objects comprising indications of questions already answered by users and content previously declined by users.

4. The system of claim 1, wherein the protocol reasoning service evaluates whether interactive buttons or rich media presentation are required for interaction intent.

5. The system of claim 1, wherein the messaging gateway comprises a protocol enforcement layer configured to override protocol recommendations when channel eligibility constraints are not satisfied.

6. The system of claim 1, wherein policy objects are revised based on subsequent user behavior contradicting prior policy assumptions.

7. The system of claim 1, wherein the bounded AI decision layer further comprises a trust estimator configured to generate readiness indicators representing inferred user engagement disposition.
